(19) United States
(12) Patent Application Publication
(10) Pub. No.: US 2006/0200381 A1
(43) Pub. Date: Sep. 7, 2006

(54) Epson digital marketing system

(75) Inventors: Sam Elkholy, Florence, MT (US); Edward WR Bagg, Port Coquitlam (CA); Vernon Fragnito, Matsumoto City (JP)

Correspondence Address: PILLSBURY WINTHROP SHAW PITTMAN LLP, P.O BOX 10500, McLean, VA, 22102, US

(73) Assignee: EPSON AMERICA INC., Long Beach, CA (US)

(21) Appl. No.: 11/072,773

(22) Filed: Mar. 4, 2005

(51) Int. Cl. G06Q 30/00

(52) U.S. Cl. 705/14

(57) ABSTRACT

A digital marketing system displays advertisements in a retail environment, in transportation vehicles, and in outdoor advertising environments. The digital marketing system includes and advertisement database, a control database, a communications network, and a plurality of digital marketing devices. The advertisement database stores a plurality of digital advertisement files for a plurality of digital marketing devices. The control database stores information about the plurality of digital marketing devices, the information including location information and log entry information. A first digital marketing device is coupled to the advertisement database and the control database via a communications network, and stores a selected set of digital advertisement files. The first digital marketing device displays the selected set of digital advertisement files according to an advertising schedule. The selected set of digital advertisement files are downloaded to the digital marketing device based on a region where the first digital marketing device is located

### BACKGROUND OF THE INVENTION

1. Field of the Invention

The present invention relates generally to improvements to in-store retail display terminals, and more particularly to advantageous aspects of a system and methods for using in-store retail service displays (e.g., display terminals or electronic signs) to display promotional data.

2. Description of the Prior Art

Consumer product advertising takes many forms, such as television commercials, newspaper and magazine advertisements, mailings, point-of-sale displays, outdoor billboards, etc. Using current advertising media, advertisers engage in a constant struggle to efficiently use their budgets to most effectively reach their geographic and demographic targets.

In point-of-sale advertising, various retail stores such as department stores, fast food restaurants, building supply stores, and the like, utilize point of purchase displays to inform customers of product specifications and pricing and to promote periodic special value or “sale” items. These point of purchase displays usually take the form of inexpensive paper product displays that are mounted adjacent to products being promoted, or displays located in a general store location (such as the entrance) to communicate more general information to consumers. Other forms of point of purchase displays may be used, such as electronic displays, for example, displays utilizing “electronic ink” technology. Current product advertising techniques do not effectively tie point of purchase displays to other forms of advertising, particularly to outdoor advertising. At present, there is no integrated system for retailers to display product promotions. Rather, a typical retail establishment relies on an assortment of signs, placards, standing cardboard displays, leaflets and other promotional materials positioned throughout the store to provide promotional information to customers.

This approach suffers from a number of disadvantages. First, it is difficult to present the promotional information to the customers in a coordinated and effective manner. Further, it is a cumbersome process to update or rearrange the promotional information, as may be required. In addition, the lack of an integrated system means that it is virtually impossible for a retailer to accumulate any kind of meaningful statistical data relating to the promotional information being displayed. The absence of these data makes it difficult for a retailer to determine the amount of money to be charged for each promotion.

There is thus a need for an automated system for displaying product promotion information to in-store retail customers in a coordinated and effective manner, and for accumulating statistical data relating to the display of the information.

In addition, conventional business methods for creating advertising require that written materials and other documentation be provided by a customer (which we will refer to herein as the user) to third party graphic artists who design the layout. The customer must wait to receive a hard-copy proof from the artists, and then, after reviewing and revising the proof, resend the proof to the artists for redesign. When the proof is finally approved, the information must be delivered to a commercial printer to produce the advertisements in their final form. At each stage of the process, there can be substantial delays. After one or more redesigns, the customer must wait for a final proof and then, once approved, wait for the final product to be produced.

The conventional process is time consuming and inefficient, and can also be very expensive relative to the cost of services that can be provided by the present invention. For example, a customer must employ the services of a graphic artist, which can add significant cost to the process. Moreover, the inclusion of a graphic artist into the process requires additional time and communications between the artist and the customer. Each time the work-in-process is transferred between parties (for example, from the graphic artist to the customer, from the customer to the graphic artist, and from the graphic artist to the printer), the work-in-process must enter the queue of the recipient, which may add uncontrollable delays, not to mention the time associated with the logistics of transferring materials. Accordingly, there is a need for an improved system that is less time consuming and less costly.

Further, current adverting tends to be static and not targeted to any particular audiences. When advertising is not related to a particular audience, there is a waste of space, time and money affiliated with the advertisement; not to mention the advertiser could have spent their advertising dollars in other more promising areas. Companies spend tens of millions of dollars every year on static advertising. These ads must be produced sometimes months in advance of the actual sale of the products—due to deadlines, flexibility is very rigid; last minute changes to content is nearly impossible, which at times can cause misrepresentation of the actual product features. Also, advertising becomes dated or trends change quickly forcing advertisers no make costly changes in the static advertising media. Another issue can occur when the advertiser assesses that the advertisement location was not suitable and a change of location was necessary. The costs associated with changing advertising locations can be substantial and the lost advertising opportunity can seriously affect a company's revenue. In addition, static advertising has become prohibitively expensive to small businesses since advertising companies require ads to be displayed for a certain period of time—sometimes long past their usefulness. Due to environmental or zoning restrictions, certain forms of advertising have been prohibited in areas where their impact/location could be positively attractive for advertisers. Accordingly, a need exists to allow for easy creating and editing of advertising media. A need also exists to allow small businesses and other personnel to select time and locations for their advertisements along with the ability to easily change the time and location.

In addition, advertising in local trains, express trains, and subways has been limited and static displays. Commuters spend many hours on these transportation modes and a majority of them do nothing to idle the time. Advertisers have a captive audience to whom they can grab their attention with information about their store, products and other unique services. Commuters also pass many locations that they have never visited and may be interested in the area or a certain product, store, etc. but never knew about the location.

### BRIEF DESCRIPTION OF THE DRAWINGS

FIG. 1(a) illustrates a digital marketing or advertising system according to an embodiment of the present invention;

FIG. 1(b) illustrates a second embodiment of a digital marketing or advertising system 100 according to an embodiment of the present invention;

FIG. 1(c) illustrates a third embodiment of a digital marketing system or an advertising system utilizing continuous mode players according to an embodiment of the present invention;

FIG. 2 illustrates a dataflow diagram of a digital marketing system including a plurality of regions according to an embodiment of the present invention;

FIG. 3 illustrates three logical layers of a data services layer of a digital marketing system according to an embodiment of the invention;

FIG. 4 illustrates an overview of a dataflow in a digital marketing system, security in the digital marketing system, and an advertisement and control database according to an embodiment of the present invention;

FIG. 5 illustrates a block diagram of the digital marketing system including a single digital marketing kiosk device according to an embodiment of the invention;

FIG. 6 illustrates a home or default ASP page for a digital marketing device according to an embodiment of the invention;

FIG. 7 illustrates an example wine selection screen that is provided from a wine selection ASP;

FIG. 8 illustrates another sample screen of an interactive digital marketing device according to an embodiment of the present invention;

FIG. 9(a) illustrates a selected events active server page according to an embodiment of the present invention;

FIG. 9(b) illustrates a selected advertisers' active server page according to an embodiment of the present invention;

FIG. 9(c) illustrates an advertisers by name screen that may be selected from the advertiser's active server page;

FIG. 10 illustrates a digital marketing system including a continuous play device according to an embodiment of the present invention;

FIG. 11 illustrates an establishment of a digital marketing system according to an embodiment of the invention;

FIG. 12 illustrates an example system new market setup page according to an embodiment of the present invention;

FIG. 12(a) illustrates a sample location maintenance screen;

FIG. 12(b) illustrates a region maintenance screen identifying the regions present in the digital marketing system;

FIG. 12(c) illustrates a kiosk maintenance input screen according to an embodiment of the present invention;

FIGS. 12(d) and 12(e) illustrate a category input menu and a category maintenance menu according to an embodiment of the invention;

FIG. 12(f) illustrates a sample advertisement maintenance screen according to an embodiment of the invention;

FIGS. 12(g) and 12(h) illustrate a banner advertisement listing (occupied space) for a digital marketing device and available advertisement lists for a region according to an embodiment of the present invention;

FIG. 12(i) illustrates an expiration ad function lists the advertisements which are about to expire;

FIG. 12(j) illustrates a coupon insertion screen according to an embodiment of the present invention;

FIG. 12(k) illustrates a customer information input screen according to an embodiment of the present invention;

FIG. 12(l) illustrates an event insertion screen according to an embodiment of the present invention;

FIG. 13 illustrates a block diagram of adding a digital marketing device according to an embodiment of the present invention;

FIG. 14 illustrates a first digital marketing device, a second digital marketing device, and a digital marketing server and downloading of content according to an embodiment of the present invention;

FIG. 15 illustrates a dataflow of downloading content to a digital marketing device according to an embodiment of the present invention;

FIG. 16 illustrates information provided by a user interface module in a digital marketing system according to an embodiment of the present invention;

FIG. 17 illustrates a flowchart of a watchdog module according to an embodiment of the present invention;

FIG. 18 illustrates monitoring of advertising and status information for digital marketing devices in a digital marketing system;

FIG. 19 illustrates a flowchart describing operation of a time and location selection advertising system according to an embodiment of the present invention;

FIG. 20 illustrates a digital marketing system including a time and location selection advertisement system according to an embodiment of the present invention;

FIG. 21 illustrates an advertisement builder software application input screen according to an embodiment of the present invention;

FIG. 22(a) illustrates an advertisement locator software application input screen according to an embodiment of the present invention; and

FIG. 22(b) illustrates an advertisement listing input screen according to an embodiment of the present invention.

### DETAILED DESCRIPTION

The present invention is directed to a digital marketing system or a digital advertising system 100 that delivers information, e.g., product information, price information, and advertising messages to customers or users at retail or at public venues. The digital marketing or advertising system includes hardware and software and allows central control of remote computing devices, such as kiosks, touchscreen computers, projectors, or in-store computers. Each of these remote devices may be referred to as digital marketing devices.

In an embodiment of the invention, each of the remote computing devices or the digital marketing devices are network addressable by a centralized digital marketing site, such as a site run by Epson America, Inc. This may also be referred to as a digital marketing system 100. Although the term “system” is utilized, the digital marketing system may include a plurality of computers or computing devices coupled to the remote computing devices (or digital marketing devices) over a communications network in order to provide updated advertising contents and schedules to the digital marketing devices. In embodiments of the invention where multiple computing devices make up a centralized digital marketing system physical site, the multiple computing devices may communicate with each other via a global communications network such as the Internet. In embodiments of the invention, the computing devices that make up a digital marketing server site may be located a number of physical locations and each of the computing devices of the Digital Marketing system site may communicate with each other via a local communications network. In an embodiment of the invention, the communication network may be a global packet-switched network or global communications network, such as the Internet. In other embodiments of the invention, the communications network may be an ATM network, a Local Area Network, or a Wide Area Network

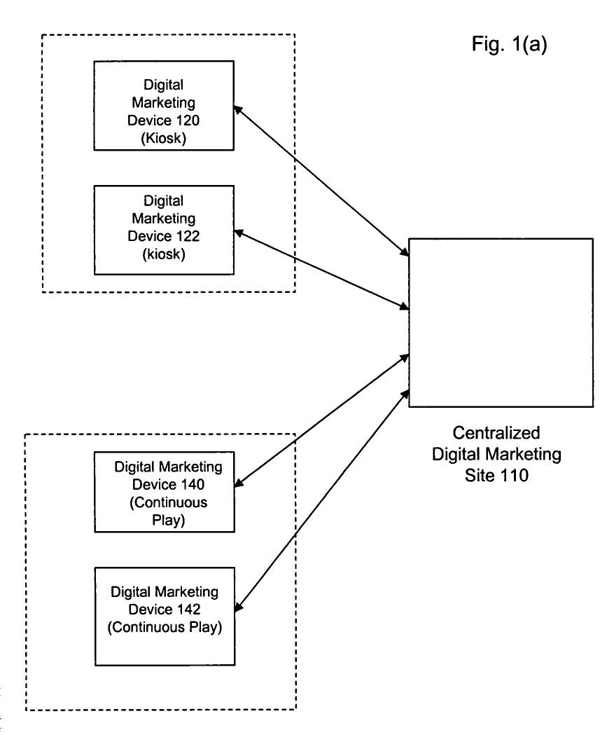

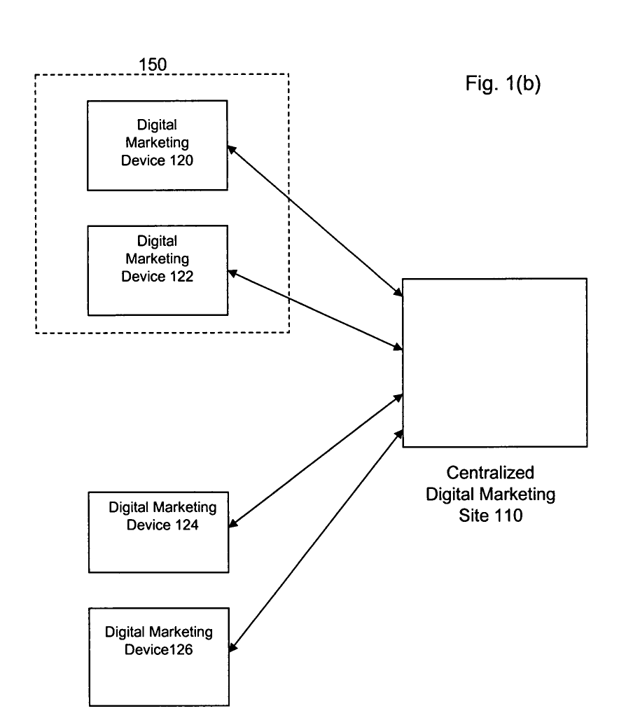

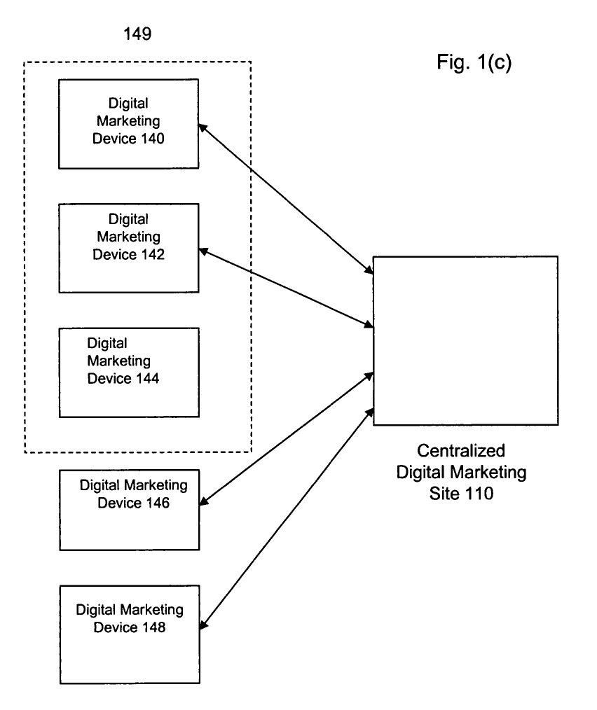

FIG. 1(a) illustrates a digital marketing or advertising system according to an embodiment of the present invention. In the embodiment of the invention illustrated in FIG. 1(a), the digital marketing system 100 may include a centralized digital marketing site 110, a digital marketing kiosk 120, and a continuous play digital marketing device 140. In the embodiment of the invention illustrated in FIG. 1(a), the digital marketing system 100 includes a plurality of kiosks 120 122, and a plurality of continuous play devices 140 142.

FIG. 1(b) illustrates a second embodiment of a digital marketing or advertising system 100 according to an embodiment of the present invention. In this embodiment of the invention, the digital marketing system 100 includes a digital marketing site 110 and a plurality of digital marketing kiosks 120 122 124 126. The kiosks 120 122 124 126 are connected to the digital marketing server site 110 via a global network, such as the Internet. In an embodiment of the invention, the digital marketing kiosks 120 122 124 or 126 may be located at separate physical locations, e.g., grocery stores, office supply stores, or other retail stores. In an embodiment of the invention, a plurality of kiosks may be located within one store, as illustrated by the dotted line 150 in FIG. 1(b).

FIG. 1(c) illustrates a third embodiment of a digital marketing system or an advertising system utilizing continuous mode players according to an embodiment of the present invention. This digital marketing system 100 includes a digital marketing site 110 and a plurality of continuous play devices 140 142 144 146 148. The continuous play devices 140 142 144 146 are connected to the digital marketing site 110 via a global network, such as the Internet. In embodiments of the invention, multiple continuous play devices may be located in the same physical location, as illustrated by the dotted line 149 surrounding continuous play devices 140 142 and 144. In embodiments of the invention, the continuous play devices 140 142 144 146 and 148 may all be located in separate physical locations.

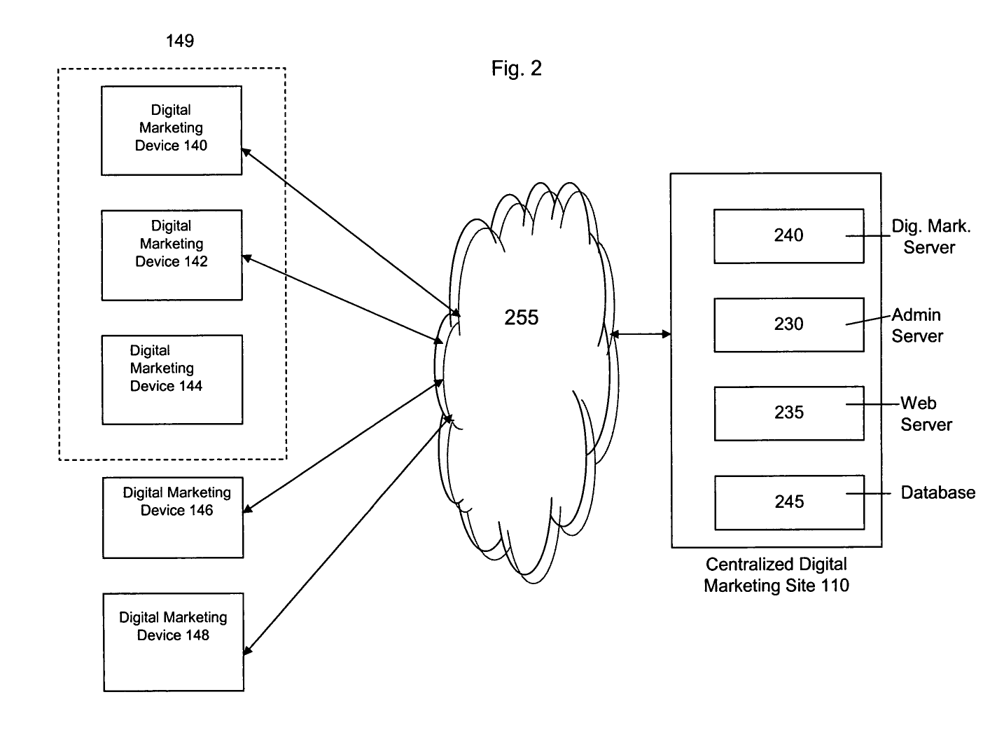

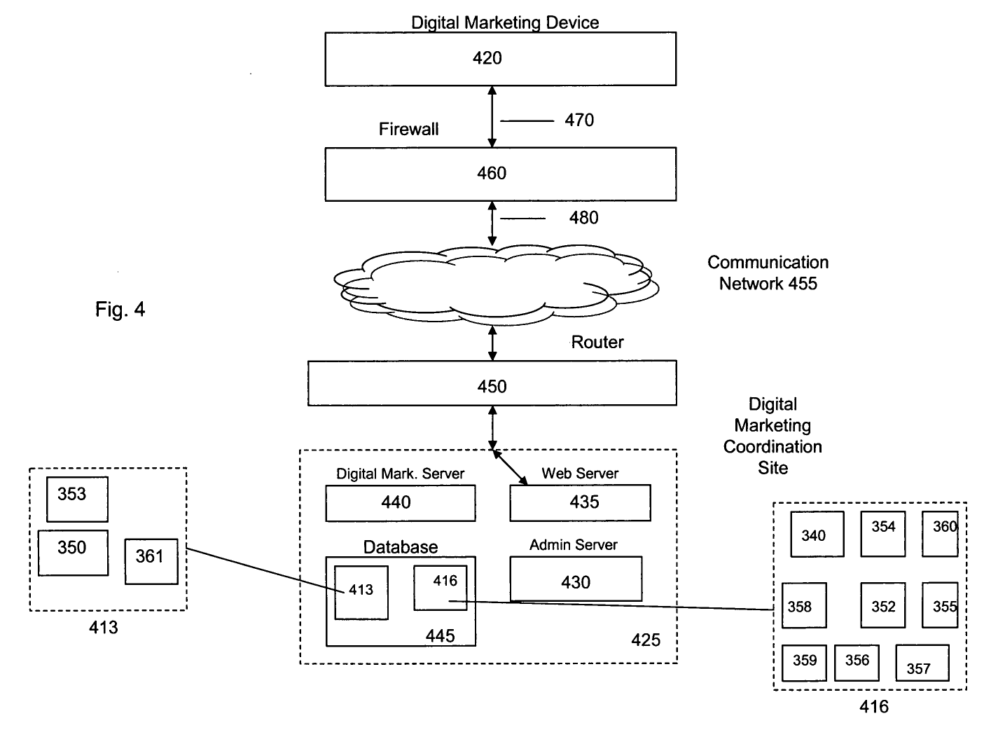

FIG. 2 illustrates a dataflow diagram of a digital marketing system including a plurality of regions according to an embodiment of the present invention. The digital marketing system 100 includes a centralized digital marketing site 110, the Internet as the communications network 255, and a plurality of client digital marketing devices 250, 260, and 270. The client digital marketing devices 250 and 260 are located in region 1 and the client digital marketing device 270 is located in region 2. The centralized digital marketing site 110 includes a digital marketing server 240 that provides advertisements to send to each of the client digital marketing devices in each region, e.g., digital marketing devices 250, 260, and 270. In an embodiment of the invention, the same advertisements may be sent to all client digital marketing devices in each region. For example, the same advertisements may be sent to digital marketing devices 250 and 260. An advertisement system 245, including an advertisement database 416 (see FIG. 4) and a control database 413 (see FIG. 4), in the centralized digital marketing site 110 may store all of the advertisements, e.g., flash files, digital videos, powerpoint presentations, and graphic files for the entire digital marketing system 100. An administration server 230 resident at the digital marketing site 110 may allow administrators to enter different advertising regions and the advertising schedules for the entered advertising regions. A web server 235 may include active server pages (ASPs) that are utilized by the digital marketing devices 148 and 146.

The digital marketing system 100 is a scalable application built on a multi-tier architecture. The digital marketing system 100 is built to run on multiple tiers of computers. Three logical tiers comprise the Epson Digital Marketing system: 1) a presentation layer or tier; 2) the business layer or tier; and 3) a data services layer or tier. The presentation logical layer includes only a small amount of data and this data is utilized to contact the business logical layer. In an embodiment of the invention, the presentation layer of the digital marketing system 100 includes Active Server Pages (ASPs), Extensible Markup Language (XML) definitions, and Visual Basic components. By separating the presentation layer and employing a multi-tier architecture, different digital marketing client devices, such as a digital marketing kiosk, a digital marketing computing device, or a continuous run digital marketing player may be utilized. The digital marketing devices operate as clients and the client software is in the presentation layer. In order to achieve this functionality, the presentation layer may have no language-specific or organization-specific text elements hard coded in the ASP pages. In alternative embodiments of the invention, language-specific or organization-specific text elements may be hard coded into the ASP pages.

The components in the business services layer are stateless components. Stateless components are achieved by having no business object in the business services layer store user-state information, because persistence data is stored in the database. The server application installed on the digital marketing server 240 and the digital marketing administration module installed in the digital marketing administration server 230 are in the business services layer. The business logic is largely placed in the Ad Management sub-layer of the business services layer and there is also business logic in the system/site management layer.

The data services layer includes the data objects that serve, or respond to data requests. The database, including the advertisement database and the control database, is also located in the data services layer. Due to the structure of the digital marketing system 100, a business object in the business services layer never talks directly to the database when requesting information. Instead, the business objects use data objects which encapsulate the data access.

The Ad management sub-layer in the business services layer serve requests from ASP pages in the presentation layer through user-interface and business-oriented interfaces. The output response from the data services layer is passed back through the business services layer to the clients in the presentation layer.

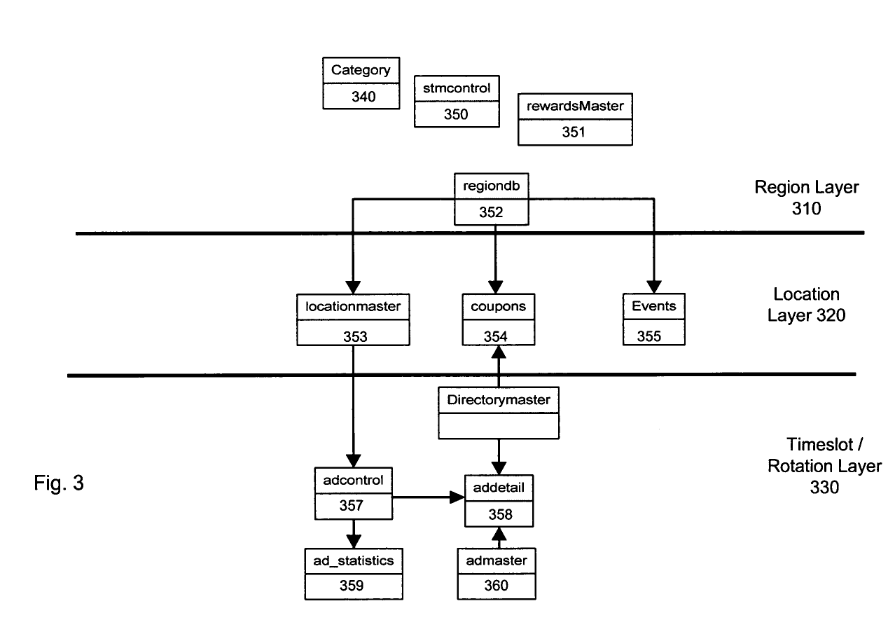

The data services layer can be represented by three logical layers. FIG. 3 illustrates three logical layers of a data services layer of a digital marketing system according to an embodiment of the invention. The regional layer 310 groups functions of ad management between various logical sets, e.g., geographical, departmental, etc. If an ad is to be manipulated, this layer is the entry point. A location layer 320 of the data services layer controls all client specific details under the regional layer from a logical point of view. Each location structure is developed specifically for a particular region. In the embodiment of the invention illustrated in FIG. 3, the location layer may include a location master structure, a coupon structure, and an event structure. A timeslot/rotation layer 330 handles the actual sequencing and presenting of the various ads scheduled to be displayed at that specific location. In an embodiment of the invention, each rotation structure may be developed for a particular location but the timeslot structure is consistent across all the locations of the site. In other words, the timeslots are the same for each instantiation of the digital marketing system. In the embodiment of the invention, the timeslot/rotation layer 330 may include a directory_master object, an adcontrol object, an addetail object, an adstatistics object, and an admaster object, each of which are described in detail below. The data services layer may also include system control module, a category module, and a rewards master module.

Control Database

| | | |
|---|---|---|
| locationmaster | LogTable | stmcontrol |

FIG. 4 illustrates database information according to an embodiment of the present invention. In an embodiment of the invention, the control database 413 may be used to store information about markets, kiosk locations and log entries. The control database 413 may also be referred to as the EPSONCTRL database. Logically, the control database 413 may include a locationmaster module or sub-database 353, a logtable 361, and a system control module or sub-database 350. Illustratively, a location master record may include the following information for each digital marketing device (e.g., kiosk or continuous-mode player) in each region and each market.

The location master record, as illustrated in the table below, for each digital marketing device includes a kiosk ID, a region ID, a region ID, an IP address of the digital marketing device, a mailing address of the digital marketing device, a city of the digital marketing device, a state or province of the digital marketing device, a zip code of the digital marketing device, a status of the digital marketing device (operating, connected, etc.), and a size of the ad rotation, i.e., a sequence number.

| Locationmaster | Type | Description |
|---|---|---|
| lm_location_id | Integer | Kiosk ID |
| rg_region_id | Integer | Region ID |
| sc_site_num | Integer | Market ID |
| lm_ip_address | Character | IP address of the |
| | | kiosk |
| lm_location_address | Character | Address of the |
| | | kiosk |
| lm_location_city | Character | City of the kiosk |
| lm_location_state | Character | Abbreviated state |
| | | or province of the |
| | | kiosk |
| lm_location_zip | Integer | Zip code of the |
| | | kiosk |
| lm_status | Character | Status of the kiosk |
| Lm_num_rotations | Integer | Size of the ad |
| | | sequence |

A logtable in the logable module 361 may be a table or a record. Under operating conditions where the logtable is a table or record, the logtable includes logged events such as how many client connections have occurred. Each entry in the log table module 361 may be associated with a digital marketing device. Illustratively, a log entry may include the following fields. The log entry may include an IP address, a name of the digital marketing device, a date the log event took place, a time the log event took place, a log event ID, and a log event description.

| Logtable | Type | Description |
|---|---|---|
| Lm_ip_address | Character | IP address of the |
| | | associated kiosk |
| Log_name | Character | Name of the |
| | | associated kiosk |
| Log_date | Date | Date the log event |
| | | took place |
| Log_time | Time | Time the log event |
| | | took place |
| Log_status_id | Character | Log event ID |
| Log_description | Character | Log event |
| | | discription |

The control database also includes a marketdefinition database or module 350. The marketdef database module includes information about the markets. Each entry in the marketdef database includes an associated database. As illustrated below, an entry may include a name of the market, a unique site ID, the name of the associated database, the number or regions within the market, the size of the ad sequence, the time of the ad sequence, a directory housing the ad sequence, when the morning ad rotation starts, when the evening ad rotation starts, when the afternoon ad rotation starts, and what types of pages are stored in the market.

| stmcontrol | Type | Description |
|---|---|---|
| Sc_site_num | Integer | Unique ID |
| Sc_site_name | Character | Name of the market |
| Sc_catalog | Character | Name of the |
| | | associated database |
| Sc_num_regions | Integer | Number of regions |
| | | in the market |
| Sc_num_rotations | Integer | Number of size of |
| | | the ad sequence |
| Sc_rotation_freq | Integer | Time each ad is |
| | | displayed |
| Sc_images_dir | Character | Directory of ad |
| | | images |
| Sc_video_dir | Character | Directory of ad |
| | | videos |
| Sc_day_starts | Time | Time the day time |
| | | slot starts |
| Sc_noon_starts | Time | Time the afternoon |
| | | time slot starts |
| Sc_evening_starts | Time | Time the evening |
| | | time slot starts |
| Sc_buttons_opt | Character | What types of |
| | | pages are displayed |
| | | in the market. |

Advertisement Database Discussion

FIG. 3 and FIG. 4 illustrate the logical structure of an advertisement database according to an embodiment of the invention. The advertisement database 416 is used to store information about advertisements, coupons, customers and events. A category sub-database 340 may include a list of coupon categories as listed below.

| Category | Type | Description |
|---|---|---|
| ct_cat_id | Integer | Unique ID |
| ct_cat_desc | Character | Short Category |
| | | name |

A DirectoryMaster sub-database or module 356 (see FIG. 4) may hold information about an advertiser, as illustrated below. In the digital marketing system, every advertisement, coupon and event has an associated advertiser.

| DirectoryMaster | Type | Description |
|---|---|---|
| dm_start_num | Character | Unique ID |
| dm_store_name | Character | Name of advertiser |
| dm_store_logo | Character | File location of |
| | | advertiser logo |
| dm_store_Address1 | Character | The address of the |
| | | advertiser |
| dm_store_address2 | Character | The address of the |
| | | advertiser |
| dm_store_city | Character | The city of the |
| | | advertiser |
| dm_store_state | Character | Abbreviation for |
| | | advertiser's |
| | | province or state. |
| dm_store_zipcode | Character | The zip code of the |
| | | advertiser |
| dm_store_contact | Character | the name of the |
| | | contact for the |
| | | customer |
| dm_store_phone | Character | Phone number of |
| | | the customer |
| dm_store_fax | Character | Fax number of the |
| | | customer |
| dm_store_email | Character | Email address of |
| | | the customer |
| dm_store_category | Integer | Business of |
| | | customer, I.E., |
| | | Food, Clothing. |

A coupon sub-database 354 may hold information about coupons. As illustrated in the table below, each coupon has an associated advertiser and region.

| Coupons | Type | Description |
|---|---|---|
| cp_coupon_id | Character | Unique ID |
| rg_region_id | Integer | Associated region |
| dm_store_num | Character | Associated |
| | | advertiser |
| cp_coupon_desc | Character | Short description of |
| | | coupon |
| cp_coupon_text | Character | Long description of |
| | | coupon |
| cp_start_date | Date | Start date of |
| | | coupon |
| cp_end_date | Date | Ending date of |
| | | coupon |
| cp_all_regions | Character | Whether coupon is |
| | | displayed in all |
| | | regions |
| cp_coupon_value | Monetary | Dollar value of |
| | | coupon |

An Admaster sub-database or module 360 may hold information about types of active server pages or web pages which are displayed on the digital marketing device (e.g., SmartTouch™ Client), as illustrated below.

| Admaster | Type | Description |
|---|---|---|
| am_page_id | Character | UniqueID |
| am_page_name | Character | Short description of |
| | | page |
| am_ad_code | Character | Same ID as |
| | | am_page_id |
| am_enabled | Character | Whether page is |
| | | going to be used. |

An addetail sub-database or module 358 may hold information about when, where and which advertisement is to be played. As illustrated by the table below, each entry in the addetail sub-database 358 has an associated region, advertiser, page ID and kiosk.

| Addetail | Type | Description |
|---|---|---|
| rg_region_id | Integer | Associated region |
| ac_kiosk_id | Integer | Associated kiosk |
| Am_page_id | Character | Page in which the |
| | | ad will be played |
| ad_ad_id | Character | The type of ad |
| Dm_store_num | Character | Associated |
| | | advertiser |
| ad_file_type | Character | The file extension of |
| | | the ad |
| ad_file_name | Character | The file name of the |
| | | ad |
| ad_layer | Integer | The sequence in |
| | | which the ad will be |
| | | displayed |
| ad_time_slot | Integer | The time slot in |
| | | which the ad will be |
| | | played, I.E, |
| | | afternoon |
| ad_begin_date | Date | Start date of the ad |
| ad_end_date | Date | Ending date of the |
| | | ad |
| ad_all_regions | Character | Whether the ad is |
| | | displayed in all |
| | | regions. |

region sub-database 352 includes a list of all regions in the digital marketing system.

| regionDB | Type | Description |
|---|---|---|
| rg_region_id | Integer | Unique ID |
| rg_Name | Character | Name of the region |

An events sub-database 355 may include a list of events. Each event in the events sub-database 355 has an associated advertiser and region, as illustrated in the table below.

| Events | Type | Description |
|---|---|---|
| me_event_id | Character | Unique ID |
| me_event_name | Character | Name of the Event |
| me_event_start_date | Date | Start date of the |
| | | Event |
| me_event_end_date | Date | End date of the |
| | | Event |
| me_event_image | Character | File location of an |
| | | image of the event |
| dm_store_num | Character | Associated |
| | | Advertiser |
| me_rec_id | Integer | Event Category |
| rg_region_id | Integer | Associated Region |
| me_all_regions | Character | Whether Event is in |
| | | all regions. |

An ad_statistics sub-database 359 may hold information about when, where and how often advertisements in the digital marketing system have been played. As illustrated by the table below, each entry in the ad_statistic sub-database 359 includes an associated region, a kiosk and an advertiser.

| ad_statistics | Type | Description |
|---|---|---|
| rg_region_id | Integer | Region in which the |
| | | ad was displayed |
| lm_location_id | Integer | Kiosk in which the |
| | | ad was displayed |
| am_page_id | Character | Page in which the |
| | | ad was displayed |
| ad_ad_id | Character | The ad type |
| dm_store_num | Character | Associated |
| | | advertiser |
| ad_layer | Integer | Ad's sequence |
| ad_time_slot | Integer | Ad's time slot |
| as_impressions | Integer | Number of time the |
| | | ad was displayed |
| as_stats_date | Date | Most recent date ad |
| | | was displayed |

An adcontrol sub-database 357 includes information about advertisements that are currently displayed on digital marketing devices 420. Each entry includes an associated region, a kiosk identifier and a kiosk IP address.

| adcontrol | Type | Description |
|---|---|---|
| rg_region_id | Integer | Associated Region |
| ac_kiosk_id | Integer | Associated Kiosk |
| lm_ip_address | Character | Kiosk IP address |
| ac_page | Character | Page Name being |
| | | displayed |
| ac_curr_ad | Integer | Current ad |
| | | sequence |
| ac_time_remaining | Integer | Time remaining on |
| | | current ad |
| | | sequence |

Security

The digital marketing system 100 includes different layers of security. Login ID codes and passwords are hard coded into the system. If modification is made to the database administrator userID, then changes need to be made to the code. Thus, in order to program in access for a new administrator to the digital marketing administrative server 430, the software code needs to be modified. Access to the digital marketing system administration in the digital marketing administrative server 430 is restricted through the common security access controls of Microsoft logon. Access to the digital marketing server 440 and the digital marketing system client 420 is also restricted by the Microsoft Windows login. Every time a server-client transaction takes place, e.g., the digital marketing device 420 contacts the central digital marketing site 110, the digital marketing server 430 verifies that a connecting digital marketing devices' IP address is present within the control database 413.

The digital marketing system 100 includes a variety of services for each of the digital marketing devices and the central digital marketing site 110. The digital marketing system 100 provides basic client side services, specifically presentation services to the digital marketing devices 120 122 124 126. The digital marketing system 100 also includes system control services, which facilitates the maintenance of the centralized digital marketing site 110 and the associated servers. Specifically, a new site or digital marketing device can be added, specific details about a region or location can be provided, and/or various transactions logs for interactions between various clients locations and the centralized digital marketing site 110.

This digital marketing system 100 includes ad management services. Ad management services include services for managing the distribution, timing, and control of advertisements. This may include the setting up of ads, obtaining details about ad activities within regions or specific locations, and setting up when ads are to be activated and expired. The digital marketing system 100 also provides file transfer service. The file transfer server handles interactions between the digital marketing devices and the centralized digital marketing site. The file transfer service, which is described in detail below, sends the ads and ad schedules from a server at the centralized digital marketing site. In some embodiments of the invention, the files and schedules are sent to a digital marketing device at a pre-scheduled time. In embodiments of the invention, the files and schedules are sent to digital marketing devices at a startup of a digital marketing device. Every transaction is logged in a database for future logging. In embodiments of the invention, a transfer of files and schedules may be manually initiated from a client device.

A client syncmaster function includes the client side of the file transfer service. The digital marketing device is responsible for initiating a request to the centralized digital marketing site for downloading the digital marketing device's ads. A syncmaster object is only created when the digital marketing device is ready to receive files. The serverfiletransfer function is the server side of the file transfer service. The serverfiletransfer function is responsible for sending the ads and ad schedules to the client based on the client's initiating request using the client syncmaster function. In an embodiment of the invention, the server filetransferservice object is created when the centralized digital marketing site 110 is contacted. In other embodiments, the server filtransfer object is initiated once a syncmaster object is created.

A client user interaction handling service handles user interaction with the client on the digital marketing devices. This service decides which ASP pages to display when an advertisements is selected. This service also decides when to display the attract loop. The client user interaction handling services also logs how often each ad is to be displayed.

The centralized digital marketing site 110 includes an administration module 430 and a server module 440. The administration module and the server module interact with the client module, where the client module is included on each of the digital marketing devices 420. The administration module 430 provides access to all ad maintenance and customer maintenance functions including the ability to add, edit, view, and remove advertisements, coupons, events and customers. The administration module 430 also includes the ability to add, edit, and view markets, regions, and/or digital marketing devices. In an embodiment of the invention, editing functions are provided though ActiveX components and viewing functions are provided through active server pages (ASPs).

The server module or digital marketing server 440 sends advertisements to the clients (digital marketing devices) and logs client (digital marketing devices 420) connections to the server module 440. The server module 440 also provides a visual view of the of all digital marketing devices, e.g., kiosks or continuous mode players, and for all regions. The client module or device 420 is responsible for displaying all advertising and other information on the digital marketing device. The client module also determines which information to display based on various factors such as time of day, location, etc.

FIG. 4 illustrates an overview of a dataflow in a digital marketing system and how security is provided according to an embodiment of the present invention.

Illustratively, a digital marketing device (client) 420 may wish to communicate with the digital marketing coordination site 425. In the embodiment of the invention illustrated in FIG. 4, the digital marketing coordination site 425 may include a digital marketing administration server 430, a digital marketing server 440, a digital marketing web server 435, and a digital marketing database 445. The digital marketing database 445 may include a control database 413 and an advertisement database 416. The digital marketing coordination site 425 may be a logical grouping. In other words, the digital marketing administration server 430, the digital marketing server 440, the digital marketing web server 435, and the digital marketing database 445 may not be physically located at the same geographical location. Illustratively, in some embodiments of the invention, each device may be physically located at a separate location, two devices may be located at one location with the two others located at a second location. Illustratively, a communication request may occur between a digital marketing client device 420 and the digital marketing web server 435, e.g., the requesting of an active server page, using, for example, a TCP/IP protocol. Under other operating conditions, the digital marketing client device 420 may initiate a communication request with the digital marketing server 440.

Initially, the communication or communication requested is transmitted to a router 450. The router 450 may be installed at the same physical site as the digital marketing web server 435. In an embodiment of the invention, the router 450 may be installed at a physical location separate from the digital marketing web server 435. The router 450 is utilized in the digital marketing system 100 to filter out unwanted incoming traffic that is being transmitted to one of the servers at the digital marketing coordination site, e.g., the digital marketing web server 435. Illustratively, the router 450 may include a list of IP addresses, corresponding to digital marketing devices, such as kiosk or continuous mode players, that have been authenticated and are authorized to communicate with the servers at the digital marketing coordination site. If the incoming communication does not originate from a device listed in the table of authorized IP addresses, then the communication request is not passed through to one of the servers at the digital marketing coordination site 425, e.g., the web server 435.

Illustratively, the router 450 transfers the communication request to the digital marketing web server 430, which receives the request and creates a communication response that is transmitted back to the digital marketing device 420. Illustratively, a new ASP may be requested from the web server 435, such as one detailing the events related to the digital marketing device 420, e.g., an event page. The response is transmitted back through the router 450 and directed through the communications network to a physical location which includes the digital marketing client device 420.

In an embodiment of the invention, a firewall 460 receives the response transmitted from one of the digital marketing coordination site servers, e.g., the web server 430, through a communications network such as the Internet or a wide-area network 455. In an embodiment of the invention, the firewall 460 may be a separate hardware device. In an embodiment of the invention, the firewall 460 may be implemented in software located on digital marketing client device 420 or another physical device installed at the retail or store location, where the physical device is logically between the communications network 455 and the digital marketing device 420. The firewall 460 may be configured to allow communication only between selected servers at the digital marketing coordination site 425, such as the digital marketing server 440 and the digital marketing web server 435, and digital marketing devices 420. In other words, no outside computing device that may be present on the communications network, either in a retail store or on the Internet, can communicate with the digital marketing device 420. Illustratively, when the firewall 460 receives incoming packets or a communication response directed to the digital marketing device 420, the firewall 460 verifies that the incoming packets originated from a server having an acceptable identifier, e.g., an IP address. As illustrated in FIG. 4, the firewall 460 may only accept communications having identifiers identifying that the communications originated from the digital marketing device server 440 or the digital marketing web server 430. If the incoming packets did not originate from one of the digital marketing coordination site 425 servers, or the internet router 450, the firewall 460 may prohibit the communication response from reaching the digital marketing device 420. In an embodiment of the invention, the connection between the digital marketing device 420 and the firewall 460 may be made via a local area network. In an embodiment of the invention, the connection 470 between the digital marketing device 420 and the firewall 460 may be made via a high-bandwidth connection line such as a DSL line. Illustratively, an ADSL communication line may be utilized. The connection 480 between the firewall 460 and the communication network 455 may be a high-speed connection such as a cable model connection, a DSL connection, or an ADSL connection.

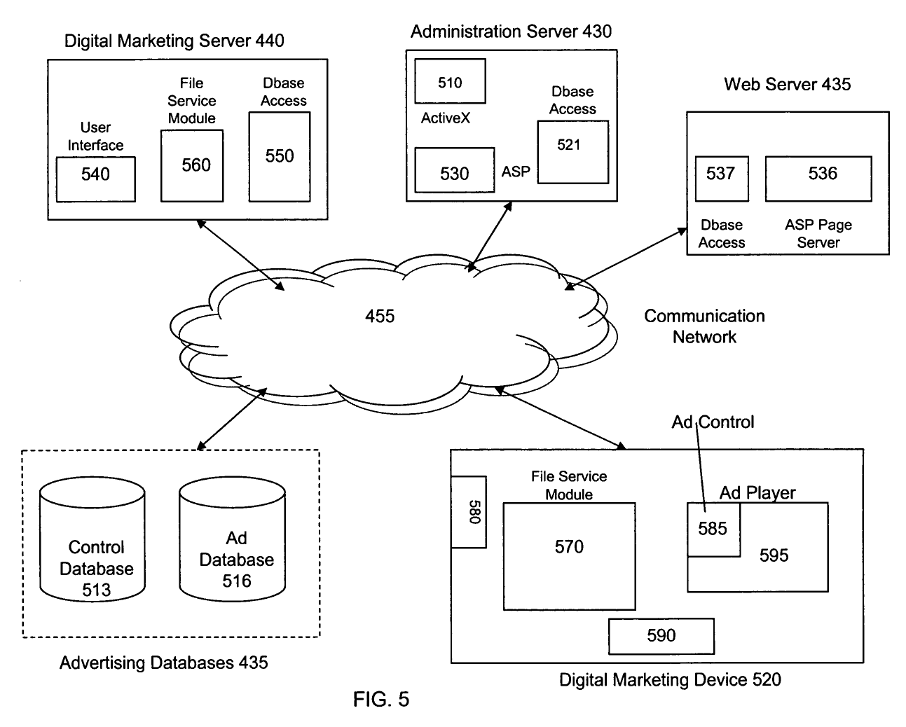

FIG. 5 illustrates a block diagram of the digital marketing system including a single digital marketing kiosk device according to an embodiment of the invention. In embodiments of the invention, a plurality of digital marketing devices 420 may be utilized. For ease of illustration, only a single digital marketing device 420 is illustrated in FIG. 5. In the embodiment of the invention illustrated in FIG. 5, the digital marketing system 100 includes a digital marketing server 440, a digital marketing administration server 430, a digital marketing database server 445 including a control database 513 and an advertisement database 516, a communications network 455, and a digital marketing device kiosk 420. As illustrated in FIG. 5, the digital marketing administration server 430 includes ActiveX controls 510, a database access module 520, and active server page module 530. The digital marketing server 440 may include a user interface module 540, a database access module 550, and a server file service module 560. The digital marketing device kiosk 420 may include a client file service module 570, a database access module 580, an advertisement control module 585, an ASP module 590, and an advertisement player 595.

The advertisement player 595 is a device or module on the digital marketing device 420 (e.g., kiosk) that presents the advertising content on a display (described below) of the digital marketing device 520. In an embodiment of the invention, the display may be, for example, a touchscreen, a computer screen, a LCD screen, or similar display devices. In embodiments of the invention, the player 595 is utilized to deliver advertisement content that can be customized by the users.

In an embodiment of the invention where digital marketing kiosks are being utilized, the digital marketing kiosk 420 may first be activated. Under certain operating conditions, the digital marketing kiosk 420 may be activated by powering on the device. Under other operating conditions, the digital marketing kiosk 420 may be in a standby state, and may be activated at a certain time of the day or in response to a user coming near (or in proximity to) the digital marketing kiosk 420, e.g., via a proximity device.

After activation, a default or initial active server page may be displayed on the digital marketing kiosk 420. Under certain operating conditions, the ASP module 590 of the digital marketing device 420 communicates with the digital marketing web server 435 and retrieves the main or default ASP page from the ASP module 536 in the digital marketing web server 435. Under certain operating conditions, the main or default ASP may be stored locally on the digital marketing kiosk 420 so initially no communication is necessary between the ASP module 590 on the digital marketing client kiosk 420 and the ASP module 536 on the web server 430.

FIG. 6 illustrates a home or default ASP page for a digital marketing device according to an embodiment of the invention. As is illustrated in FIG. 6, different advertisements are placed in different areas of the display screen of the digital marketing kiosk 420. Each of the placeholders for the advertisements on the display screen may be referred to as an advertising slot. As illustrated in FIG. 6, the default ASP page may also include links to an event active server page, an advertiser active server page, and a main wine selection active server page. In embodiments of the invention, these active server pages (event, advertiser, and main wine selection) may be located locally on the digital marketing device or may be hosted on a web server.

In the embodiment of the invention illustrated in FIG. 6, the main ASP or default page includes 8 advertising slots. Six of these advertisement slots are one size, with each of the two other advertisements different sizes. Under other operating conditions, the number of advertisements may be smaller or larger. For example, the number of advertisements on a screen may be three advertisements or may be five advertisements. Under certain operating conditions, the advertisements that are placed or displayed in the eight advertising slots are stored locally in the digital marketing kiosk device 420. The advertisements (or advertising content) may be stored in a non-volatile memory which is part to the digital marketing device file service module 570. Under other operating conditions, the advertising content may be stored in a non-volatile memory in the digital marketing device kiosk 420 apart from the file service module. As will be described below, the file service module 570 receives updated advertisements or advertisement files from the advertisement database on a periodic or regular basis. The ad control module 585 operates and controls locations of the advertisements within the ASP (which advertising slot the advertisement is inserted into), how long each advertisement in each advertising slot should run, and what hour or section of the day the advertisement should run. This information is downloaded in an advertisement control file or an advertisement schedule from the file service module 560 of the digital marketing server 430.

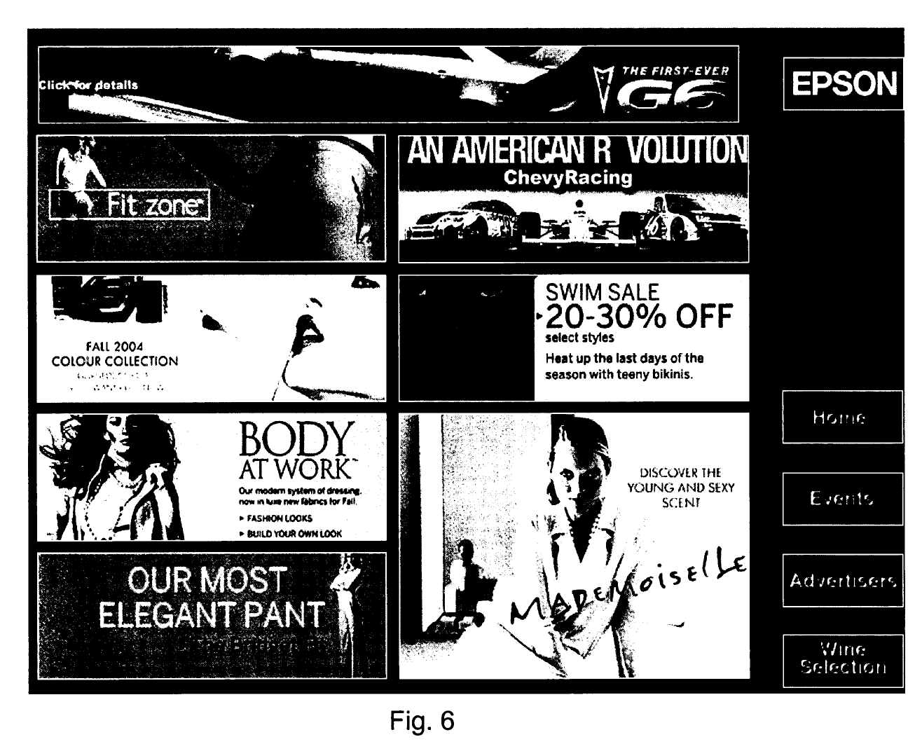

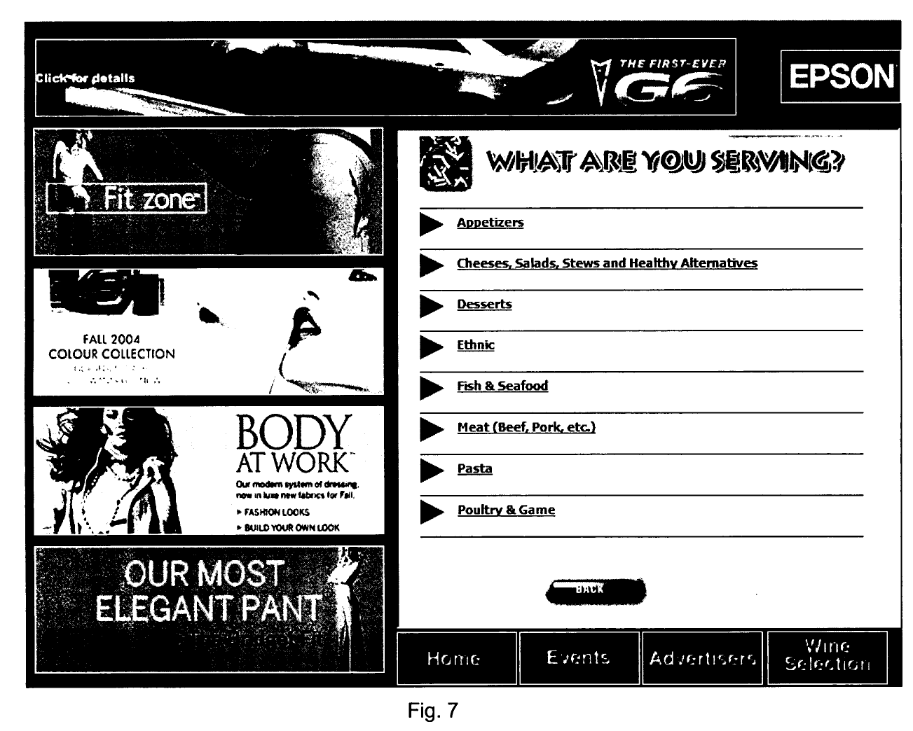

Under certain operating conditions, a different screen on the digital marketing kiosk 420 may be selected for display. Illustratively, on FIG. 6, the wine selection screen may be selected from the main user or default screen of the digital marketing kiosk 420. FIG. 7 illustrates an example wine selection screen that is provided from a wine selection ASP. FIG. 7 is displaying results of input wine selection criteria and is displaying four wines that are recommended via the digital marketing kiosk 420.

Illustratively, if the wine selection page (FIG. 7), is selected for display, the ASP module 590 in the digital marketing device makes a request to the ASP module 536 in the digital marketing web server 435 to retrieve the selected ASP. A copy of the ASP, which may be thought of as a template or container, is transferred from the ASP module 530 in the digital marketing web server 435 to the ASP module 590 in the digital marketing kiosk 420. The selected ASP is then displayed on the screen of the digital marketing kiosk 420. The active server pages may be templates that are established by advertising creators, corporate marketing personnel, or system administrators. Advertising creators may be owners of the retail stores, advertising consultants, or operators of the central server, e.g., Epson America Inc. The active server page creators create the active server web pages, utilizing standard web page authoring programs. As illustrated in FIG. 5, the advertising creators or operators may store the created web pages, e.g., active server pages, in an ASP module 536 of the digital marketing web server 435. Accordingly, when a digital marketing device kiosk 420 requests a new active server page, the new active server page may be retrieved from the ASP module 536 of the digital marketing web server 435.

A selected active server page may include the same number of advertising slots as the default or main active server page or it may include a different number of advertising slots. As illustrated in FIG. 7, the main or default active server page includes eight advertising slots and the wine selection ASP includes five advertising slots. When the ASP module 590 of the digital marketing kiosk 420 receives the selected active server page, the ad control module 585 supplies the new number of advertisements to the advertisement slots in the selected ASP. The ad control module 585, because the new or selected active server page is now running, adjusts to the new or selected ASP and only directs the displaying of five advertisements. Illustratively, the ad control module 585 would control the placement of ads into and duration of running for the five advertisements slots in the selected ASP. The advertisements to be displayed in the advertisements slots are stored locally on the digital marketing kiosk 420, in either a separate non-volatile memory or within the file service module 570 of the digital marketing kiosk 420. The selected ASP may include links or pointers to the advertisements which are placed in the advertising slots and the retrieving and then displaying of the retrieved advertisements may be controlled by the Ad control module 585.

The ASP module 536 of the web server 435 may include a plurality of active server pages that may be displayed on the digital marketing kiosk 420. Each time, a user selects a new or different ASP for viewing, the ASP module 590 of the digital marketing kiosk 420 and the ASP module 536 of the web server 435 communicate and interact to retrieve the new or different ASP and download it to the digital marketing kiosk 420.

In an embodiment of the invention, all the ASPs may be stored locally on the digital marketing kiosk 420 in the ASP module 590. This may be advantageous when only a small number of ASPs are utilized by the digital marketing kiosks 420 and thus a large amount of memory on the digital marketing kiosk 420 would not be utilized to store the active server pages locally.

If the digital marketing kiosk 420 is not being utilized by a user or after initialization of the device 420, the display screen of the digital marketing kiosk may be utilized to attract customers in retail establishments over to the digital marketing kiosk 420. A non-volatile memory in the file server module 570 of the digital marketing kiosk 420 or a separate non-volatile memory in the digital marketing kiosk 420 may store an attract loop that is utilized to attract customers to investigate the digital marketing kiosk 420. The attract loop may be an eye-catching video, an eye-catching flash animation, an image, etc. The attract loop content may also include embedded sound files that could be transmitted to a speaker in the digital marketing kiosk 420 and played to attract the customer or user. The attract loop could be played by the ad player 595 after a pre-determined time period where there has been no user activity (such as when no new ASPs have been selected in the last five minutes), upon initialization of the digital marketing kiosk 420, or at designated periods of the day. The playing of the attract loop is controlled by the ad control module 585 of the digital marketing kiosk. Once a user interacts with the device, e.g., touches the touchscreen of the digital marketing kiosk 420, the main or default ASP for the digital marketing kiosk 420 is displayed.

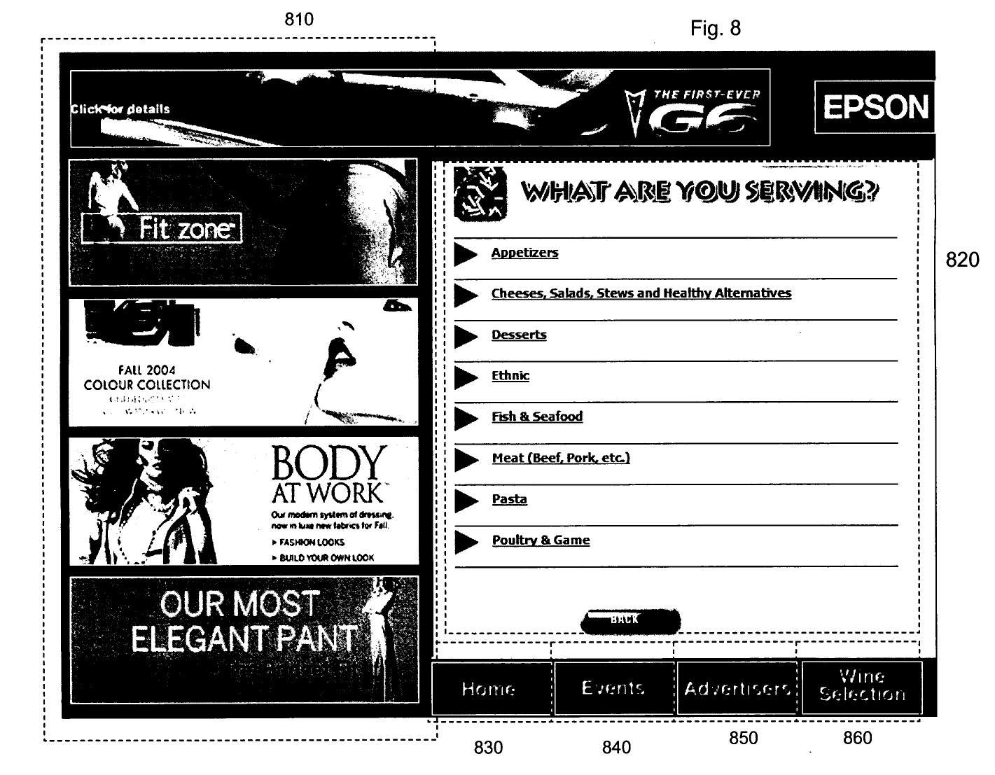

FIG. 8 illustrates another sample screen of an interactive digital marketing device according to an embodiment of the present invention. The display screen illustrated in FIG. 8 includes five banner advertisement slots 810 (e.g., where ads for the Gap, Maybelline, and Pontiac are displayed), a selection menu 820 (e.g., a “What Are You Serving” menu), a home button 830, an events button 840, an advertisers button 850, and a wine selection button 860. In an embodiment of the invention, the ad control module 585 of the digital marketing device 520 supplies advertisements for the five banner advertisement slots 810 from the file service module 570 or non-volatile storage to the player 595. The ad control module 585 controls what advertisements are placed in which banner advertisement slots 510, how frequently the ads are rotated to another advertisement, etc. In other words, this information is available locally on the digital marketing device 820.

The selection menu 820 (the “What Are You Serving” menu) may include a list of selection that a user or operator of a digital marketing 520 may desire more information about. In the embodiment of the invention illustrated in FIG. 8, an active server page is displayed in the selection menu which allows the user to select from between 1) appetizers, 2) cheeses, 3) desserts, 4) ethnic food, 5) fish & seafood, 6) meat, 7) pasta, or 8) poultry/game. When a link or item on the selection menu 820 is chosen, e.g., the desserts link is chosen, the digital marketing device 520 may retrieve the corresponding active server page from an ASP page server 536 located on a web server 435. The selected or corresponding active server page, in this case the one for desserts, is then displayed as the new selected menu 820. Each of the linked selection choices has a corresponding active server page located or stored in the ASP page server 536 in the web server 435. In an embodiment of the invention, the web server 435 is remote or physically separate from the digital marketing device 520. As illustrated in FIG. 5, the web server 435 may be remote and separate from other digital marketing servers (such as the administration server 430 or the digital marketing server 440). In other embodiments of the invention the web server 435 may be co-located with the digital marketing server 440 or the digital marketing administration server 430.

Illustratively, the home or central button 830 may be selected by the user from the display screen of the digital marketing device 520. The home or central button 830 selects a home page that has been pre-determined by a digital marketing system administrator or operator. In an embodiment of the invention, if the home or central button 830 of the display screen is selected, the digital marketing device 520 may retrieve, from an internal ASP module 590, the active server page corresponding to or designated as the starting point (or home page) of the digital marketing system. Because this home page is frequently accessed, it may be resident on the digital marketing device 520.

Under other operating conditions, a user or operator may select an events selector 840, an advertisers' selector 850, or a wine selection selector or button 860. The digital marketing system operator 520 may include other selector buttons on the display screen of the digital marketing kiosk 520 based on the utilization and marketing focus of the digital marketing system 100. Each of these selectors or selector buttons (events, advertisers, and/or wine selection) are referring to information that is likely stored outside of the local digital marketing device 520. In an embodiment of the invention, these buttons link to active server pages resident in the ASP module 590 of the digital marketing device 520. In an embodiment of the invention, these buttons link or request active server pages resident in an ASP page server in the web server 435.

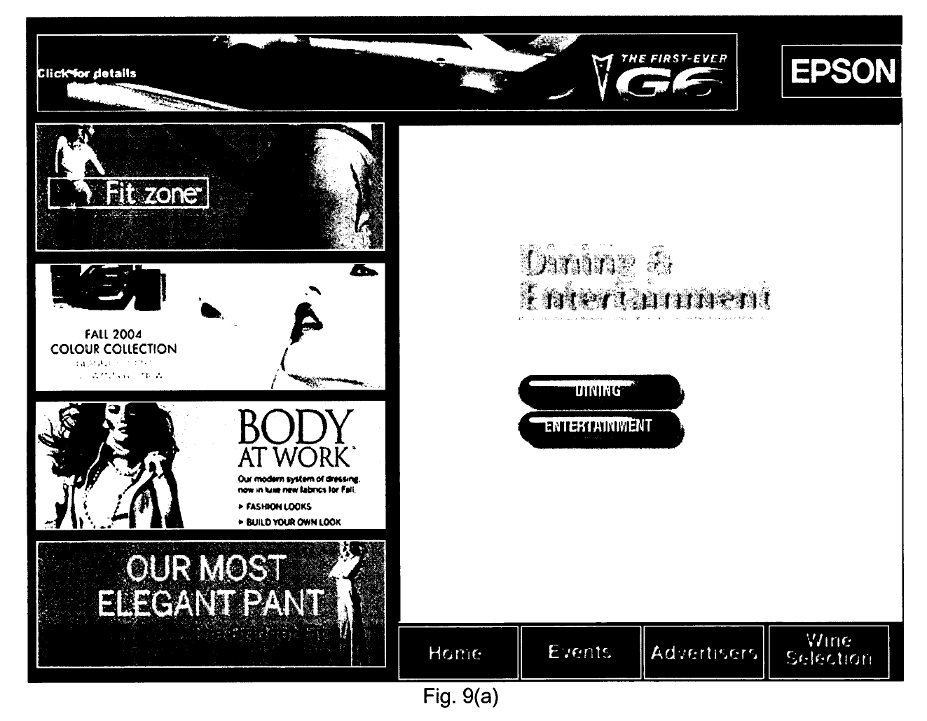

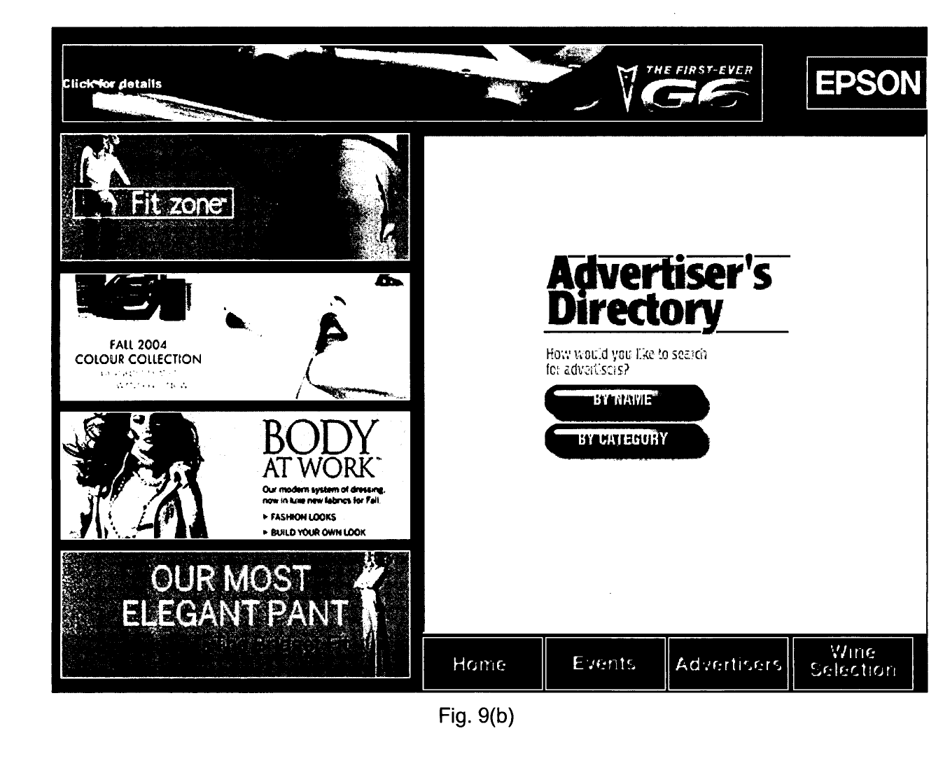

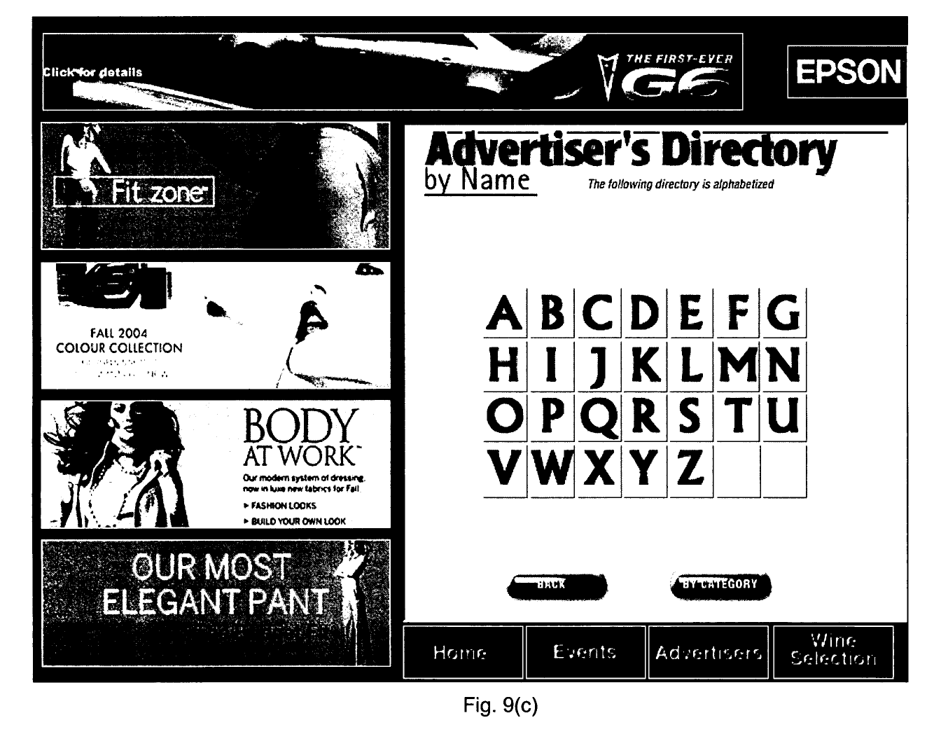

FIG. 9(a) illustrates a selected events active server page according to an embodiment of the present invention. FIG. 9(b) illustrates a selected advertisers' active server page according to an embodiment of the present invention. FIG. 9(c) illustrates an advertisers by name screen that may be selected from the advertiser's active server page. Under certain operating conditions, these active server pages (illustrated in FIGS. 9(a), 9(b), and 9(c)) are stored in the digital marketing web server 435, e.g., the ASP page server 536. Under certain operating conditions, the web server 435 may need to communicate with the control database 513 to gather information to populate the requested ASP. The web server 435 may contact the control database 513 utilizing the communication network 455. Illustratively, if the user selects the Advertisers by Name ASP, the database access module 537 of the web server 435 may communicate with the control database 513 to gather the necessary information regarding the advertisers. For example, the control database 513 may provide the names of all the advertisers which begin with the letter “E”. The web server 435 may combine this information into the requested ASP and transmit the populated ASP to the digital marketing device 520.

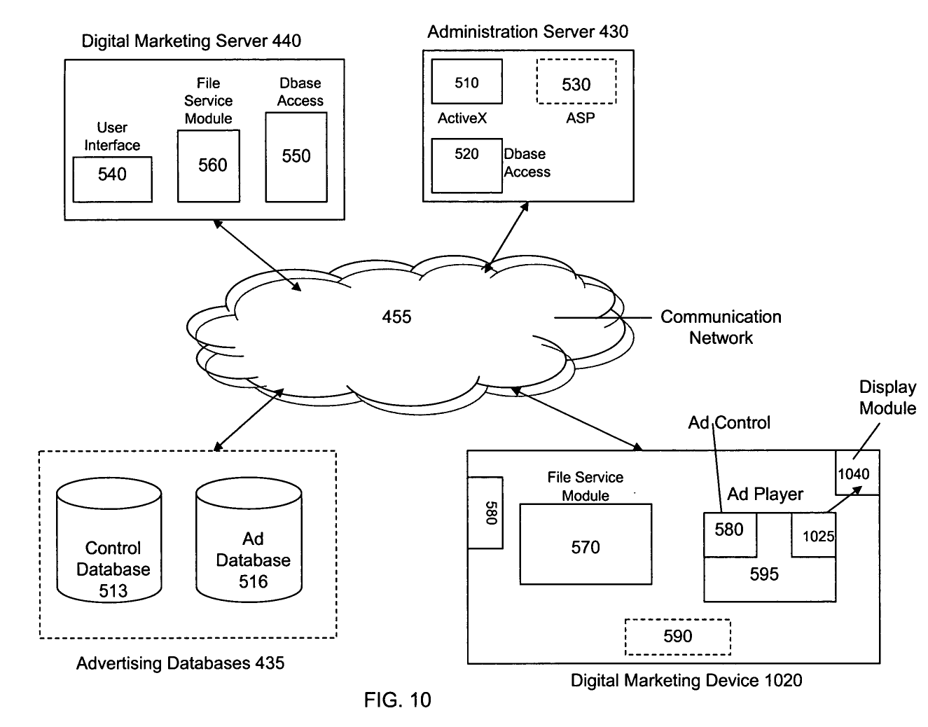

FIG. 10 illustrates a digital marketing system including a continuous play device according to an embodiment of the present invention. Digital Marketing device 1020, e.g., continuous play device, may not include interactive screens. In embodiments of the digital marketing system where continuous play device are utilizes, ASP pages may be utilized as screens that automatically rotate according to a downloaded advertising schedule. In other words, the digital marketing system utilizing continuous play devices may have display devices that look or appear similar to the digital marketing systems with kiosks, but the digital marketing device ad control module 580 may make the selection rather than having the user select an option on a touchscreen of a digital marketing kiosk.

In embodiments of the invention, ASP pages may not be utilized by the continuous play digital marketing devices 1020. In this embodiment of the invention, the web server 435 may not be utilized in the digital marketing system 100. An administration server 430 is still utilized to establish or initially setup the control database 513. In embodiments of the invention where continuous mode digital marketing devices 1020 are utilized, the player 595 may include a video decoder 1025. The player 595 receives the advertisements from the file service module 570 in the continuous play digital marketing device 1020. The advertisements are run through the video decode 1025 and sent to the player 595 for display. The ad control module 580 of the digital marketing device 1020 controls the playing of the advertisements. Under certain operating conditions, the ad control module 580 retrieves an advertising play schedule or playlist from the file service module 570, e.g., a downloaded advertising schedule. Under other operating conditions, the ad control module 585 already includes the advertising play schedule. The advertising play schedule or playlist identifies the advertisements to be displayed by the continuous play devices 1020, when they are to be displayed, and how long the advertisements are to be displayed. The continuous play digital marketing devices 1020 may include computing devices with plasma monitors or may be a projector and a projector screen. Under certain operating conditions, the continuous play digital marketing devices 1020 may display only one advertisement at a time. Under other operating conditions, the continuous play marketing devices may play or project multiple images onto a projector screen or display multiple images on a plasma screen.

Generally, the video decoder 1025 in the player 595 receives an advertisement file, decodes the advertisement file, and transfers the decoded advertisement file to a display module 1040 of the digital marketing continuous play device 1025. In embodiments of the invention utilizing projectors, a display module 1040 receives the decoded advertisement file and projects the advertisement onto a screen. In this embodiment of the invention, the display module 1040 may continue to project the same advertising file, repeatedly, for a scheduled period of time.

The Digital Marketing System 100 allows the system to be customized at a local level and a regional level while delivering an impression that the digital marketing system 100 is a professional national advertising program. The Digital Marketing System 100 is able to incorporate and handle video commercials, static video billboards, internet banners, customer retails banners, and potentially internet e-commerce.

In order to establish a digital marketing system 100 for a corporation or an organization, the corporation or organization is established as a new market. After the new market has been established, the advertising and region sections may be established for the new market. Illustratively, 15 digital marketing devices may be established as a first region, 20 digital marketing devices may be established as a second region, and six digital marketing devices may be established as a third region. Each of the different regions may have different advertising schedules. In other words, different sequences or displays of advertisements may be established for different regions.

FIG. 11 illustrates an establishment of a digital marketing system according to an embodiment of the invention. The new market is established by logging into the digital marketing administration server 430. The administrator may utilize the active X module 510 and the ASP module 530 to establish the digital marketing system 100. The digital marketing administration server component is written in Microsoft™ ASP and Visual Basic ActiveX Controls. In an embodiment of the invention, the advertising database 516 and the control database 513 are written in and operate in MS/SQL 2000. The Active X module 510 is primarily used for database maintenance and ASP pages of the ASP module 530 are used as containers for the Active X module 510. Illustratively, the ASP module 530 may store ASP pages that are utilized to design and initialize the digital marketing system 100. In other words, these ASP pages allow data entry to establish the digital marketing system. If control or setup information is being input by the administrator or digital marketing system establisher, the information may be transferred from the administration server 430 to the control database 513 via the communication network 455. Illustratively, the database access module 520 of the administration server 430 may send the input information to the control database. If advertisements or information regarding the advertising schedule are being input into the digital marketing system, then this information may be transferred from the administration server 430 to the advertisement database 516. Again, the database access module 520 may be utilized to transfer this information to the advertisement database 516. Certain information input via the administration server 430 to either the control database 513 or the advertisement database 516 may be utilized to generate active server pagers that may be stored in the ASP page server 536 of the web server 435. For example, an advertiser's by name ASP page may be stored on the ASP page server 436. This information, after the administrator has established the digital marketing system 100, may be transferred from the control database 513 to the web server 435. The web server 435 may receive the information, create an active server page utilizing the information, and store the active server page (e.g., for advertisers' by name) in the ASP page server 536.

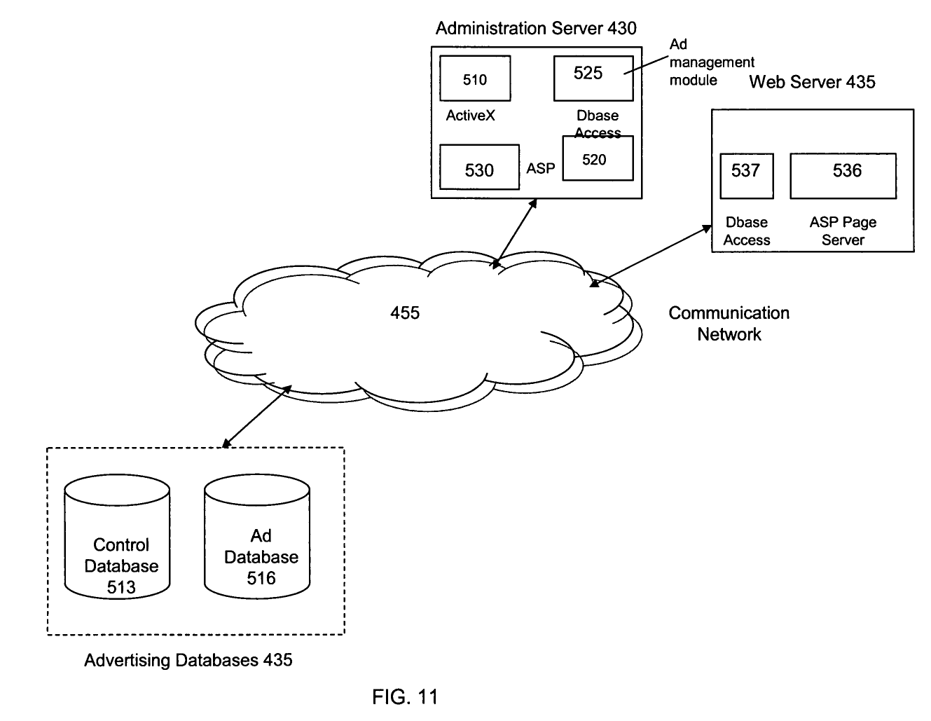

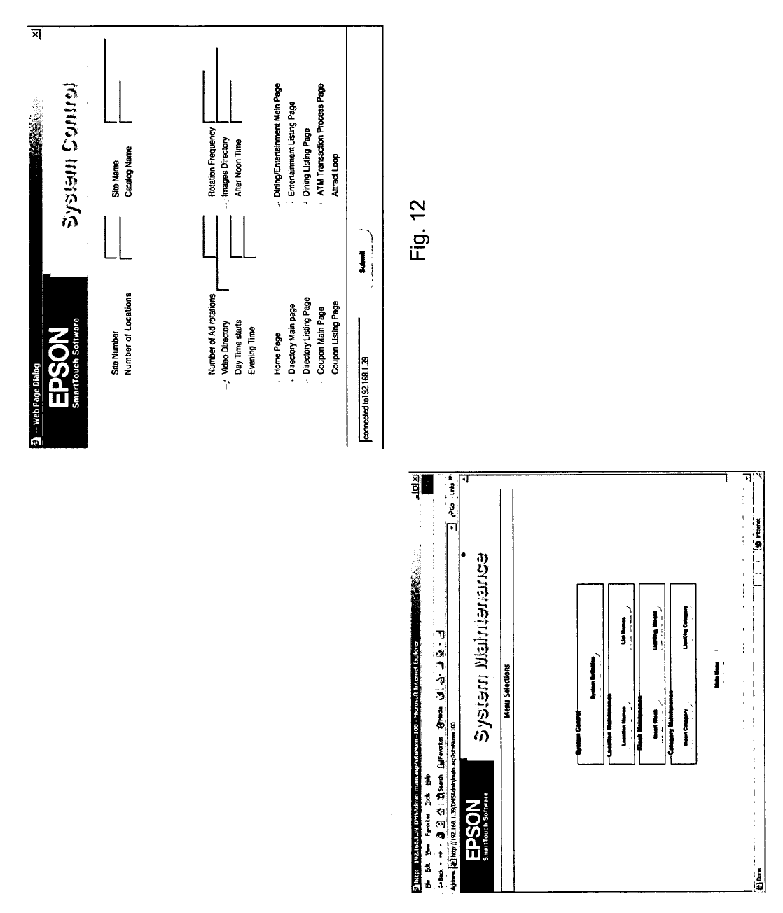

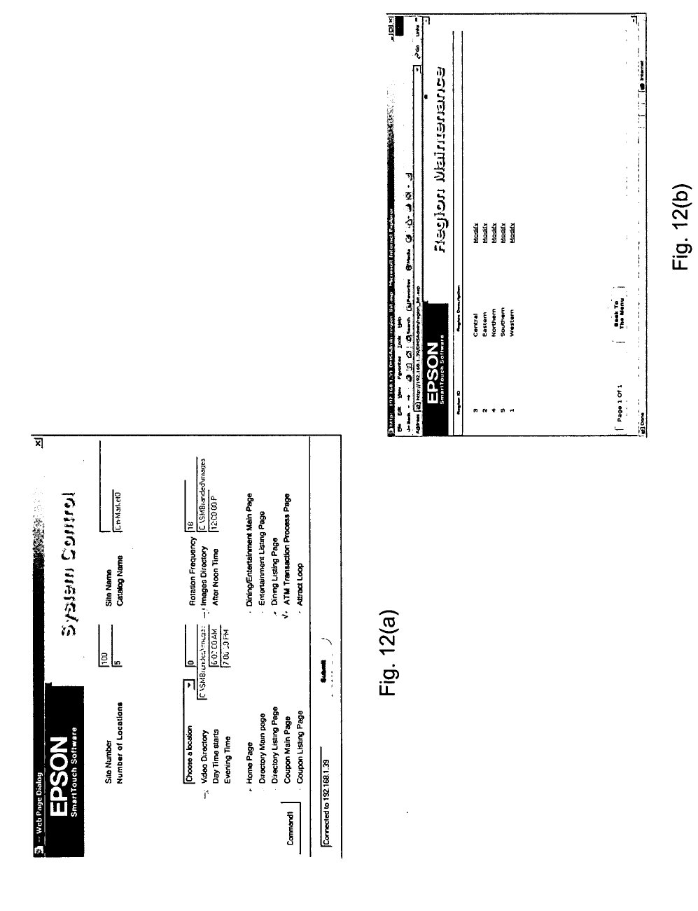

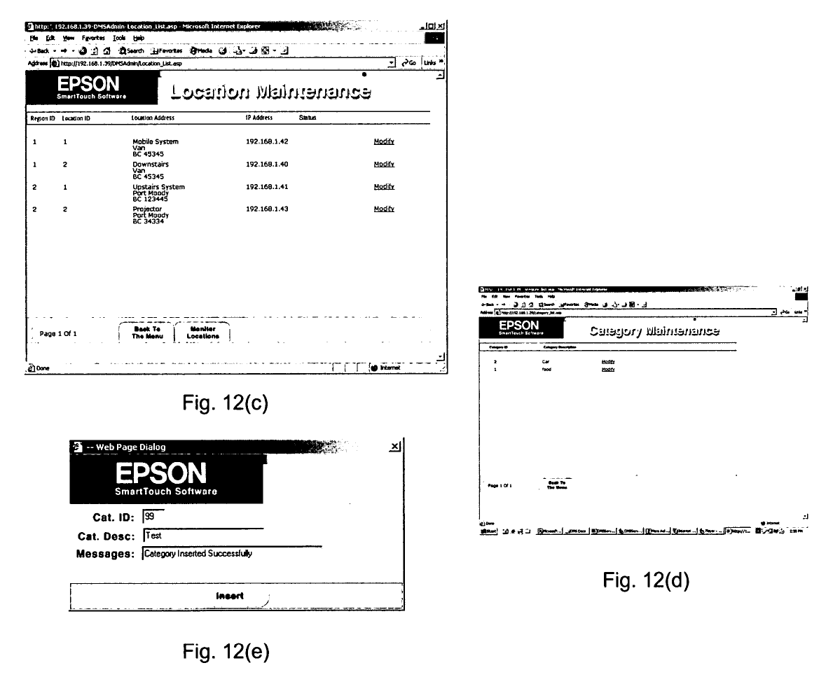

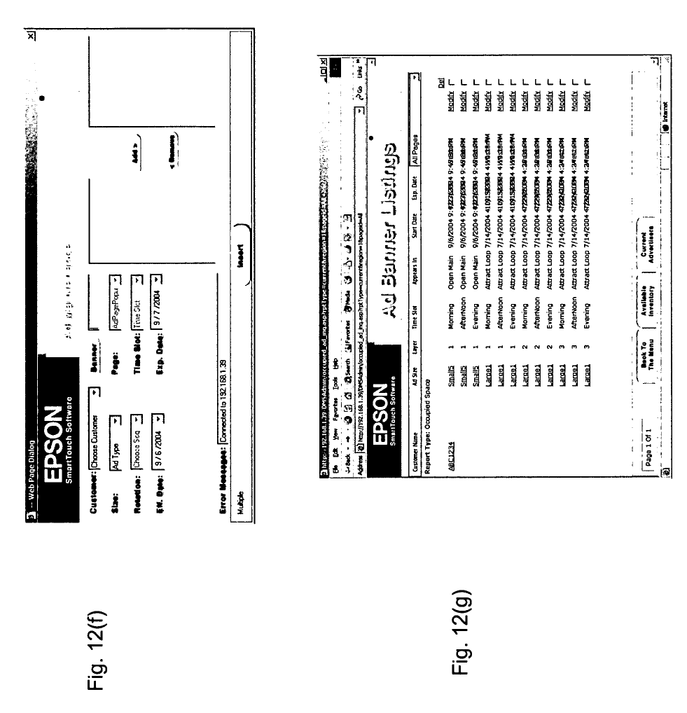

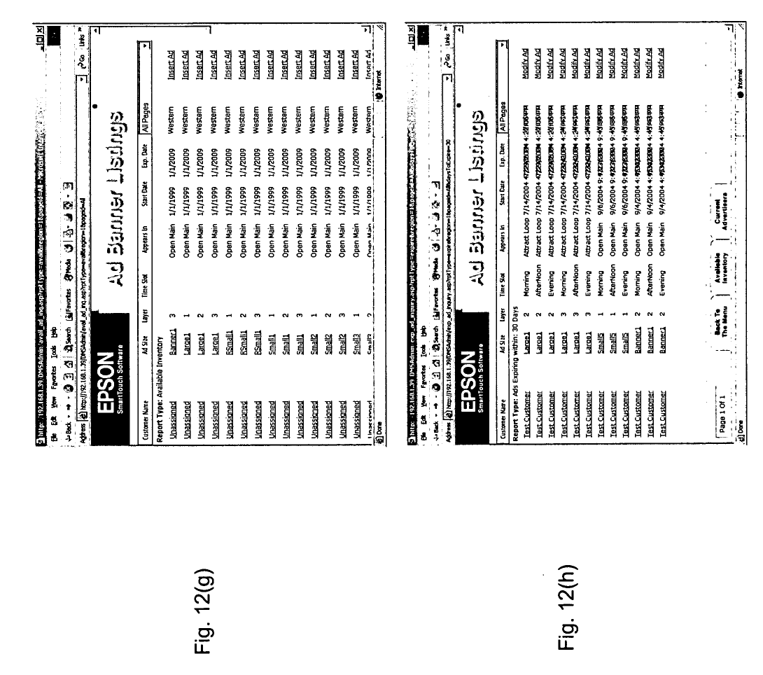

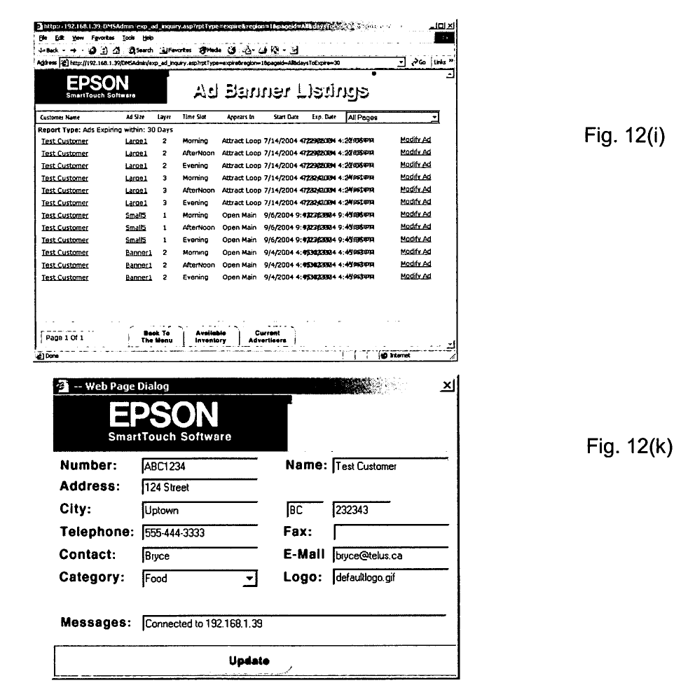

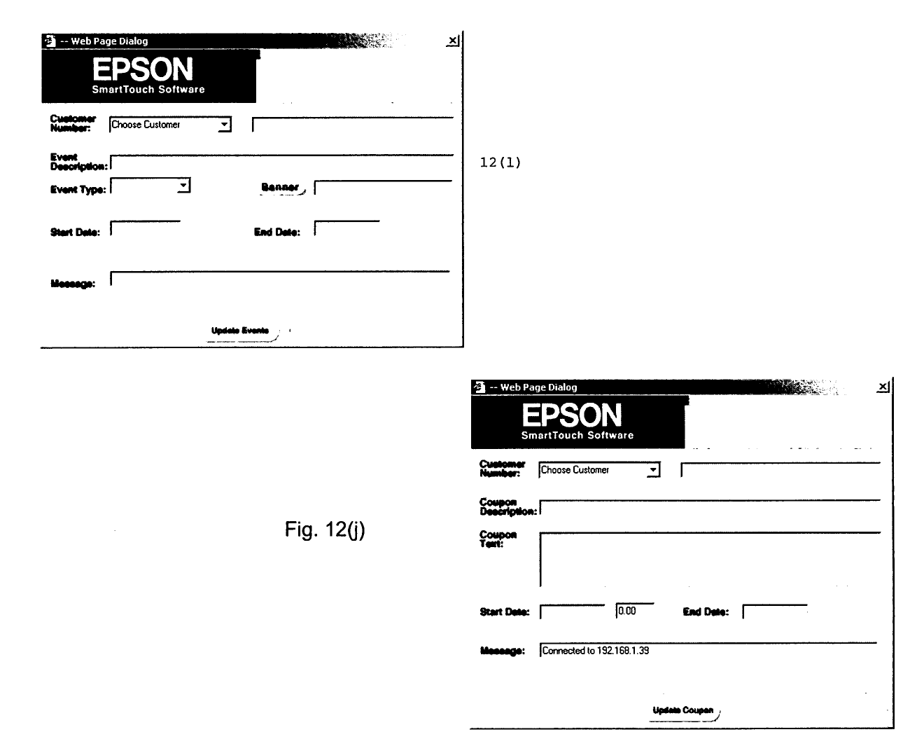

FIG. 12 illustrates an example system new market setup page. Illustratively, a site number and name should be entered to identify the market, e.g., the GAP digital marketing system, the EPSON Projector digital marketing system. A number of sites, e.g., a number of digital marketing devices, are entered into the new market setup page. In addition, a location of a database being utilized as the control database 513 and a location of the advertisement database 516 are entered into the new market setup page.

Next, a number of ad rotations are entered. In other words, this number illustrates a maximum number of advertisements that may occupy a single advertising slot. Illustratively, if 50 is entered in this field, 50 advertisements could run in one advertising slot on a selected active server page. A rotation frequency identifies the number of advertisements each occupied slot rotates between.

A location where all of the advertising videos are stored is entered into the new market setup page. The location may be the location of the advertisement database 516. The advertisement database 516 may be located in the same physical location as the digital marketing administration server 430 or may be located in a separate physical location. A location is also identified where the advertisement images are stored. This location will also be resident within the advertisement database 516.

Each advertisement may also be assigned a time period of the day in which the advertisement is to be run. Under certain operating conditions of the digital marketing system, up to three time periods may be selected. Illustratively, the time period may be day time, afternoon time, and evening time. In the new market setup page, the time period is defined, i.e., day time is defined as being 8:00 am—Noon; afternoon time is noon to 5 pm, and evening time is 5 pm to 10 pm.

A user may identify that a home page of the digital marketing system may include advertisements. If the home page is not identified as including advertisements, then the digital marketing system may include self-promotion advertisements, such as advertisements for the retail store chain or specials within the store. A user may also identify, in the market setup page whether or not the following active server pages or web pages are to include advertisements or promotions from the advertisement database (as illustrated in FIG. 12): the Directory Main Page, the Directory Listing Page, the Coupon Main Page, the Coupon Listing Page, the Dining/Entertainment Main Page, the Entertainment Listing Page, the Dining Listing Page, and even the Attract Loop. After this information is entered, the digital marketing system stores this information at the digital marketing control database 513.

After the new market has been established, regions within the digital marketing system 100 may be defined. For example, five regions, West, Southwest, North, South, and East may be entered into a location maintenance screen. FIG. 12(a) illustrates a sample location maintenance screen. After the regions or locations are entered into the digital marketing administration server 430 and stored in the digital marketing control database 513, the regions can be listed to verify that all regions have been entered. FIG. 12(b) illustrates a region maintenance screen identifying the regions present in the digital marketing system 100.

After the regions have been established, each of the digital marketing devices may be defined in the digital marketing system 100. For each kiosk, a location and location id are entered which correspond to the region where the kiosk is located. The IP address and the location address of the digital marketing kiosk are also input. Under certain operating conditions, the information could be batch loaded into the administration server 430 for each digital marketing kiosk 420 in the digital marketing system. FIG. 12(c) illustrates a kiosk maintenance input screen according to an embodiment of the present invention. The information for the kiosks may be modified or changed. A list/change kiosk function may allow the location id, the IP address, and the location address to be changed for each digital marketing kiosk 420.

The digital marketing system 100 categorizes the coupons, events, advertisements, and promotions. This allows the digital marketing system to search the digital marketing advertising database 516 for specific types of advertisements, coupons, events, or promotions. Initially, categories are entered into the digital marketing system 100. In an embodiment of the invention, a category ID, a category description, and a message for each advertisement, coupon, event, or promotion category are entered. After the ID, description, and corresponding message are entered, this information may be listed or changed utilizing a category maintenance function. FIGS. 12(d) and 12(e) illustrate a category input menu and a category maintenance menu according to an embodiment of the invention.

An ad management module 525 of the digital marketing system 100 may be accessed by a sales staff or client marketing personnel. The ad management module 525 allows the insertion, deletion, or modification of advertisements, coupons, events, or promotions in real-time. The ad management module 525 schedules the time of day and the location for particular advertisements. The ad management module 525 automatically expires any ads when the customer's contract expires with the administrator of the digital marketing system 100. The ad management module 525 schedules coupons per locations.

The ad management module 525 allows the insertion of advertisements in specific locations. A customer, or advertiser, can be selected. The location for the advertisement and the size for the individual advertisement may also be selected. The active server or web page or pages where the advertisement is to be displayed may also be selected. The place in the rotation queue of advertisements may also be selected. Illustratively, sales personnel or administrators may input three which means that the advertisement is third in the rotation queue. The time slot for the advertisement may also be selected, e.g., daytime, afternoon time, and evening time. An effective date and expiration date may be input for the advertisement. In addition, region or regions can be entered where the advertisement is to be displayed. After all of the information is input, the ad is inserted and stored in the advertisement database. FIG. 12(f) illustrates a sample advertisement maintenance screen according to an embodiment of the invention.

The advertisements for the digital marketing system 100 may be listed along with available space, the current advertisers, and the ads about ready to expire. The selection of occupied space provides a list of the advertisements entered into the digital marketing system 100. An available inventory function provides a list of the available inventory of advertisements. The current advertisers function (or active server page) lists the current advertisers for the digital marketing system 100. An available space function lists the available space for a selected kiosk or continuous mode digital marketing device in the digital marketing system 100. The advertisements can be viewed and advertisements may be inserted utilizing this function. Illustratively, the advertisements that are available to be inserted may be listed. FIGS. 12(g) and 12(h) illustrate a banner advertisement listing (occupied space) for a digital marketing device and available advertisement lists for a region according to an embodiment of the present invention. An expiration ad function allows the selection of a location and the selection of a number of days (within days) in which the advertisements are to expire. The expiration ad function lists the advertisements which are about to expire as illustrated in FIG. 12(i).

The digital marketing system 100 allows the insertion of coupons, the changing of coupons, searching for coupons by number, and searching for coupons by name. Specifically, the digital marketing administration server 430 includes the ad management module 525, which also manages the coupons. In order to insert a coupon, first a location needs to be determined as to where the coupon is to be displayed. After the location is identified, a customer number or advertiser is entered along with a coupon description, coupon text, a start date on which the coupon is to be displayed, a coupon amount, and end data on which the coupon is stopped from being displayed. The coupon is saved into a file on the digital marketing advertising database 516. Each coupon in the system may be entered in a similar fashion. FIG. 12(j) illustrates a coupon insertion screen according to an embodiment of the present invention. The coupon information for each coupon may also be edited. The ad management module 525 provides the functionality for editing of each coupon.

The ad management module 525 of the digital marketing system 100 may provide searching of all the coupons in the advertisement database 516 by customer number. First, a location can be selected. Then, a customer number is selected and the searching coupons by number function may be selected. A list of the coupons is then provided. After the list has been provided, the coupons can be edited or modified from the presented list of coupons. Similarly, searching of all the coupons in the advertisement database by coupon name is provided by the ad management module 525. A coupon name may be entered and the ad management module 525 may present a list of the coupons meeting the coupon name criteria.

The digital marketing system 100 allows for the entering of a customer or advertiser, the changing of information for the customer or advertiser, the search for a customer by number, and the search for customer information by name. Initially, in order to insert a customer or advertiser, a location is selected. The ad management module 525 of the digital marketing system 100 requests the entry of the new customer number, the customer name, the customer address, the customer city, the customer state, the customer zip code, the customer telephone number, fax number, contact person, and e-mail address. In addition, a category of advertisement is selected for the customer and an image name or image path corresponding to a logo for the customer is also entered. This information is then stored in the digital marketing administration server 430 and the control database 513. FIG. 12(k) illustrates a customer information input screen according to an embodiment of the present invention.

The ad management module 525 allows for changing of the customer number. The customer number is selected and the entered information is displayed. Changes may be made to the entered customer information and the newly updated information may be saved into the control database 513.

The ad management module 525 of the digital marketing system 100 may provide searching of for customer information by customer number. First, a location can be selected. Then, a customer number is selected and the searching for customer number function may be selected. The customer's information is then displayed. After the list has been provided, the customer information can be edited or modified from the presented list of customer information. Similarly, searching of all the customer information in the control database 513 by customer name is provided by the ad management module 525. A customer name may be entered and the ad management module 525 may retrieve a list of the customer names and related information meeting the customer name criteria from the control database 513.

The digital marketing system 100 allows the insertion of events, the changing or editing of events, searching for events by customer number, and searching for events by event name. Specifically, the digital marketing administration server 430 includes the ad management module 525 to perform these functions. In order to insert an event, first a location needs to be determined as to where the event is to be displayed. After the location is identified, a customer number or advertiser is entered along with an event description, an event type, a start date on which the event is to be displayed, an end date on which the event is stopped from being displayed. In addition, the logo which was entered in the customer information section can be selected by utilizing a banner input. The banner input allows the selection of the location for the banner. The event is saved in the control database 513. Each event in the digital marketing system may be entered in a similar fashion. FIG. 12(l) illustrates an event insertion screen according to an embodiment of the present invention. The event information for each coupon may also be edited or modified. The ad management module 525 provides the functionality for editing or modification for each event.

The ad management module 525 of the digital marketing system 100 may provide searching of all the events in the advertisement database 516 by customer number. First, a location can be selected. Then, a customer number is selected and the searching events by number function may be selected. A list of the events matching the customer number is provided. After the list has been provided, the events can be edited or modified from the presented list of events. Similarly, searching of all the events stored in the advertisement database 516 by event name is provided by the ad management module 525. The ad management module 525 searches the control database 513 in order to compile this list. An event name may be entered and the ad management module 525 may present a list of the events meeting the event name criteria.

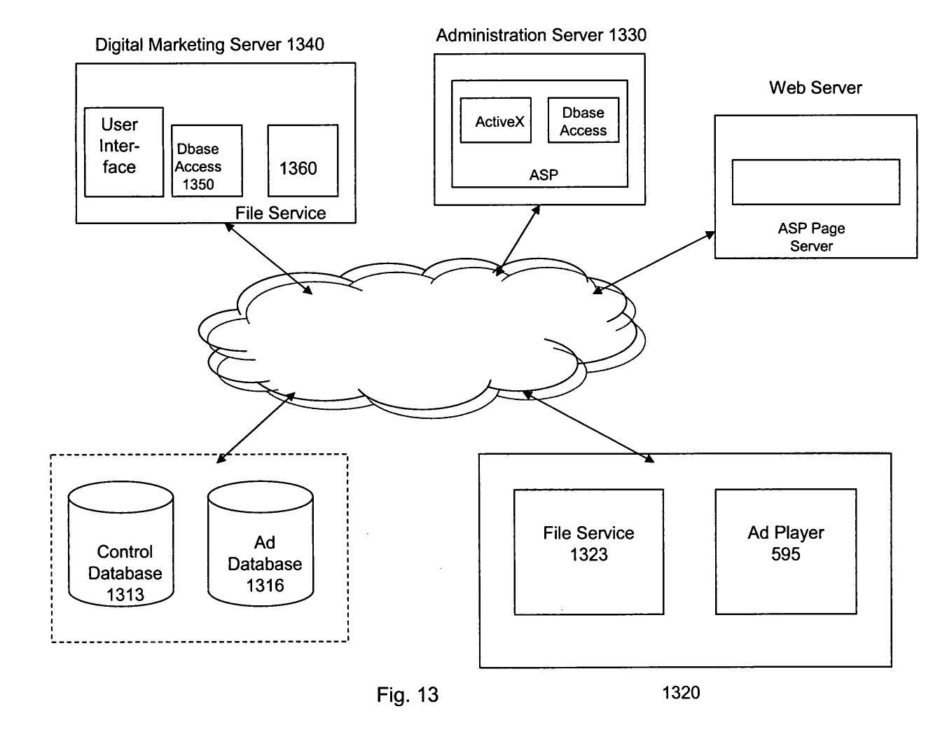

The digital marketing system 100 allows for easy modification and scalability. FIG. 13 illustrates a block diagram of adding a digital marketing device according to an embodiment of the present invention. Digital marketing devices may be easily added to the digital marketing system 100. The digital marketing device 1320 may include a network identifier address, such as an Internet Protocol (IP) address. This may enable the digital marketing server 1340 to recognize the digital marketing device 1320 when the digital marketing device wishes to communicate with the digital marketing server. For example, the digital marketing device 1320 may be assigned an Internet Protocol (IP) address. After the digital marketing device 1320 is assigned a network identifier address, which normally occurs during setup of the digital marketing system 100 by the administration server 1330, records are stored in the control database 1313. The control database 1313 may include a table listing all of the operable digital marketing devices, such as digital marketing clients 1320, the types of digital marketing devices (e.g., interactive such as kiosks or continuous such as players), and associated network identifier addresses.

Illustratively, a digital marketing device 1320, upon a first initialization, may transmit a content downloading or content updating request to the digital marketing server 1340. The digital marketing server 1340 is monitoring or listening for content downloading requests from digital marketing devices, such as digital marketing device 1320. For example, the file service module 1360 on the digital marketing server 1340 may be listening on a user-specified port utilizing the TCP/IP protocol. Under certain operating conditions, this port may be port 1001 or may be another port that is selected by the operator or administrator of the digital marketing server 1340. Upon receiving the content downloading request from the digital marketing device 1320, the file service module 1360 of the digital marketing server 1340 verifies that the network identifier address is stored in the control database 1313. The file service module 1360 contacts the database access module 1350 which in turns communicates with the control database 1313. In one embodiment of the invention, the table may be in the control database 1313 running as a SQL server. If the file service module 1360 verifies that the digital marketing device's IP address is stored in the table, e.g., is located in the control database 1313, the file service module 1360 retrieves the advertising content from one of the advertising databases 1316. The drawings illustrate the advertising database 1316 as one physical database, but the advertising database 1316 may be comprised of multiple physical database servers. For example, each region could include a separate physical database storing its own advertising content. The advertising content stores both the advertising files, e.g., flash files, macromedia files, media files, music files, along with an advertising schedule (a schedule on when the advertisements are to be played by the player 595). Under certain operating conditions, the advertising schedule may be an extensible markup language (XML) file. Under certain operating conditions, the advertising schedule may be stored in the advertising database. Under certain operating conditions, the advertising schedule may be stored in the control database. Under other operating conditions, the advertising schedule may be created in the digital marketing server 1340 as transfers are taking place. The file service module 1360 of the digital marketing server 1340 proceeds to begin downloading the advertising content and/or advertising schedule to the digital marketing device 1320. Under certain operating conditions, the digital marketing server 1340 may also transmit an attract loop to the digital marketing device 1320.

The advertising content may be a plurality of files. In the advertising loop, there may be files having format types of JPEG, MPEG, Flash, GIF, or other formats. Similarly, the attract loop may include a plurality of files having file format types of JPEG, MPEG, Flash, and GIF.

Under certain operating conditions, the advertising loop files or the attract loop files may be compressed before they are downloaded form the file service module 1360 of the digital marketing server 1340. This minimizes the downloading time between the digital marketing server 1340 and the digital marketing device 1320.

The advertising loop, the attract loop, and/or the advertising schedule may be updated on a periodic basis. Illustratively, the advertising loop may be updated daily. In order to minimize the downloading time, the update may occur during early morning hours, such as midnight to 6:00 am. If a network for a digital marketing system 100 has been established including 100 digital marketing devices, each of the digital marketing devices may have a scheduled time in which to contact the file service module 1360 in the digital marketing server 1340 in order to update the advertising loop, the advertising schedule, and/or the attract loop. The scheduled digital marketing device 1320 may transmit a content request update to the file service module 1360 of the digital marketing server 1340. The file service module 1360, as described above, may verify, with the control database 1313, that the scheduled digital marketing device 1320 is a valid digital marketing device. After the file service module 1360 verifies the digital marketing device 1320, the file service module, in conjunction with the control database 1313 and the advertising database 1316, may evaluate which advertising files may have changed since the requesting digital marketing device 1320 last requested downloaded advertising content. Illustratively, the requesting digital marketing device 1320 may request an updated advertising content on a daily basis. The file service module 1360 receives the advertising content update request, checks an update table in the control database 1313 to determine if any updates have occurred, and also to determine what files will need to be downloaded. The file service module 1360 may store this information. For example, the stored information may indicate that in the last day that a new jpg file may have been added and that a flash file may have modified. In this example, the file service module 1360 of the digital marketing server 1340 would transmit or transfer these two files (e.g., the new jpg file and the modified flash file) to the file service module 1360 of the requesting digital marketing device 1350.

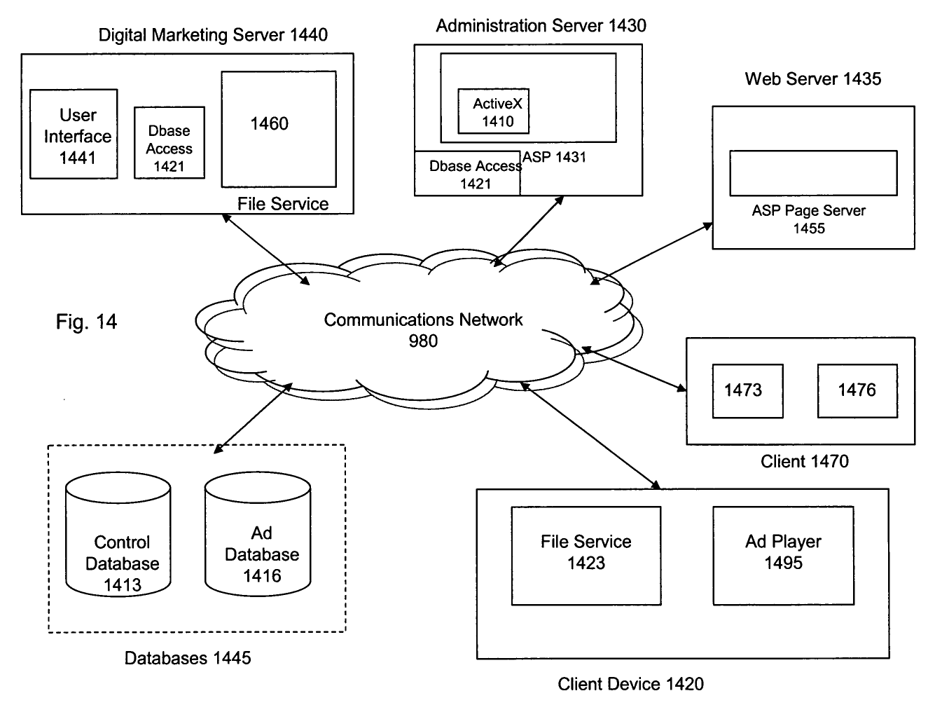

FIG. 14 illustrates a first digital marketing device 1420, a second digital marketing device 1470, and a digital marketing server 1440 and downloading of content according to an embodiment of the present invention. The digital marketing system 100, e.g., the digital marketing server 1440, may simultaneously download content information or advertising information to multiple digital marketing devices, e.g., digital marketing devices such as digital marketing device 1420 and 1470, as illustrated in FIG. 14. In an embodiment of the invention, an advertisement database 1416 may load advertising files into the file service module 1460 of the digital marketing download server 1440. The advertising files that are downloaded may be large, e.g., 5 MBs or 10 MBs, in total. If multiple digital marketing devices 1420 and 1470 are requesting the downloading of advertising files and/or an advertising schedule simultaneously, a large amount of memory is consumed in the digital marketing server 1440. In this embodiment of the invention, because the entire group of advertising files and the advertising schedule may be loaded into the memory of the file service module 1460 of the digital marketing download server 1440 at one time, the performance of the digital marketing server 1440 may be negatively impacted. Under certain operating conditions, the speed at which the advertising content and the advertising schedule is downloaded may be compromised and may not occur as fast as if one or two digital marketing devices are utilized.

In a second embodiment of the digital marketing system 100, a large number of digital marketing devices, e.g., digital marketing devices 1420 and 1470 and multiple other digital marketing devices, may access the digital marketing server 1440, download the updated advertising files and/or updated advertising schedule, all at the same time. Although a large number of digital marketing devices, e.g., 50 digital marketing devices, may simultaneously download updated advertising content files and updated advertising schedules, the method or process described below involves only two digital marketing devices for ease of illustration.

In an embodiment of the invention, a first remote site or digital marketing device 1420 may desire to upgrade or replace some or all of its advertising content from the advertising database 1416. Illustratively, 1) an advertiser or customer may change the ads they have purchased in the digital marketing system, 2) a new advertiser may purchase time and supply new advertisements, 3) a new promotional video may have been created by the store or retail establishment, or 4) a new advertisement schedule for the region including the first digital marketing device 1420 may have been generated. Under certain operating conditions, only a few advertisements files may be downloaded to the digital marketing device 1420 and under other operating conditions, a large number of files, e.g., all of the advertisements currently being utilized by the digital marketing device 1420 and the advertising schedule, may be downloaded to the digital marketing device 1420.

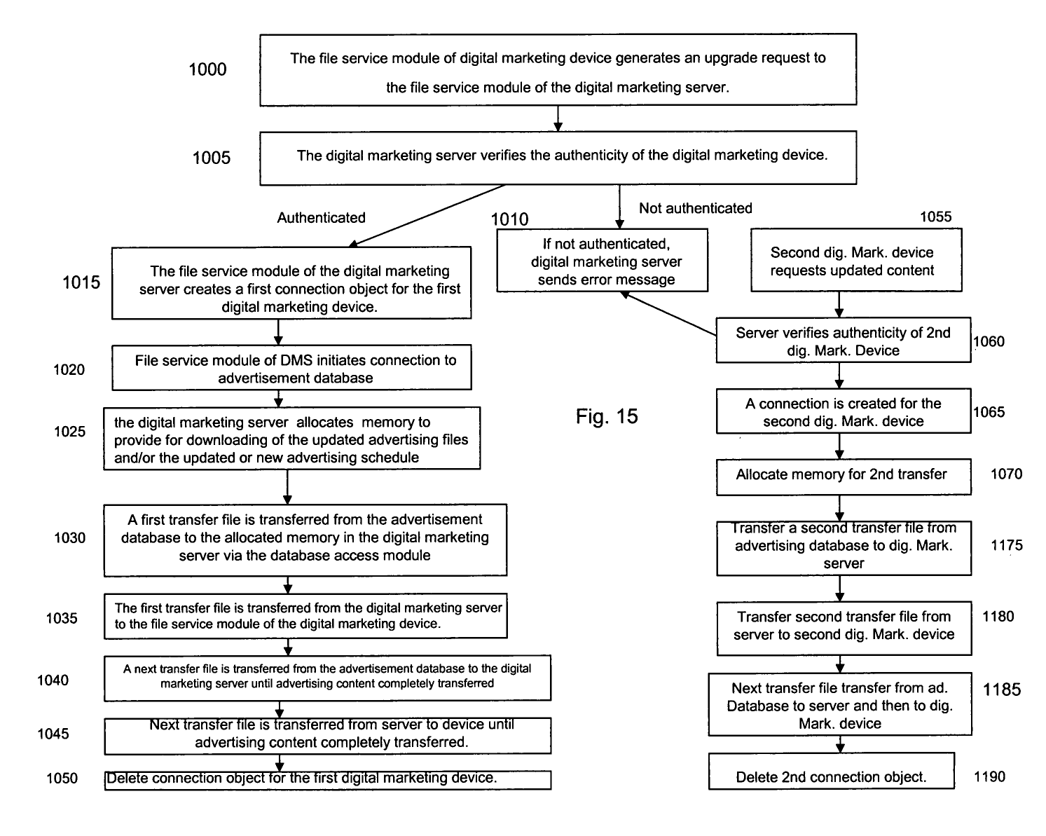

FIG. 15 illustrates a flowchart of downloading content to a digital marketing device according to an embodiment of the present invention. Initially, the file service module 1423 of digital marketing device 1420 may generate and transmit an upgrade request 1000 to the file service module 1460 of the digital marketing server 1440. After the digital marketing server 1440 of the Epson Digital Marketing system is contacted by the first digital marketing device 1420, the digital marketing server 1440 verifies 1005 the authenticity of the digital marketing device 1440. In one embodiment of the invention, the database access module 1421 of the digital marketing server 1440 contacts the control database 1413 to verify that the contacting digital marketing device 1420 has been established and setup in the digital marketing system 100. In other words, the digital marketing server 1440 makes sure that the requesting digital marketing device 1420 is one of the registered kiosks or continuous mode players of the digital marketing system 100. Illustratively, in one embodiment of the invention, the control database 1413 includes a table listing all of the registered digital marketing devices and corresponding identifications, e.g., IP addresses. Illustratively, the file service module 1460 may extract the IP address from the incoming upgrade request, transmit the IP address via the database access module 1421 to the control database 1413, and the control database 1413 compares the IP address to the registered IP addresses in the authentication table. If the IP address is not in the authentication table, the request is denied by the file service module 1460 and an error message is transmitted 1010 and sent to the system operator and/or the digital marketing device 1420.

If the first digital marketing device 1420 is authenticated, then the file service module 1460 of the digital marketing server 1440 creates 1015 a first connection object or connection thread for the first digital marketing device 1420. The first connection object or connection thread may be hold information regarding the actual download and files to be downloaded. The first connection object may include customer information, download information, and digital marketing device information. The connection object or connection thread may include digital marketing device identification, i.e., an IP address or a location name. The connection object or connection thread may include a current duration time for the download or current connection. The connection object or thread may also include information regarding the status of the download or connection. Illustrative, but not limiting information, may include a 1) time that the download started; 2) the region or type of record that the connection object is downloading the information from; 3) the latest file in the group of files that has been downloaded during this connection; or 4) the latest group or chunk of data in the latest file that has been downloaded during this connection.

After creating the connection object or thread, the digital marketing server 1440 initiates 1020 a connection to the digital marketing advertising database 1416. The connection creates a communication channel between the digital marketing advertising database 1416 and the digital marketing server 1440 via the database access module 1421 to transfer the requested updated files from the digital marketing advertising database 1416 to the file service module 1460 of the digital marketing server 1440. In addition, the digital marketing server 1440 allocates 1025 memory to provide for downloading of the updated advertising files and/or the updated or new advertising schedule.

In an embodiment of the invention, the digital marketing advertising database 1416 divides up the updated advertising content, e.g., the updated advertisements and/or the updated advertisement schedules, into chunks or transfer files. In order words, the updated advertising content is divided into portions or smaller files. A temporary memory in the digital marketing advertising database 1416 may store one or multiple transfer files. The first transfer file may be extracted from the updated or new advertising content and/or schedules. Then, the first transfer file is transferred 1030 from the advertisement database 1416 to the allocated memory in the digital marketing server 1440 via the database access module 1421. Because the transfer size file has a small manageable size, e.g., 300 KB or 500 KB, a large amount of memory may not be necessary in the digital marketing server 1440. In an embodiment of the invention, the first transfer file may be transferred to a memory in the file service module 1460 of the digital marketing server 1440. The first transfer file may then be transferred 1035 from the file service module 1460 of the digital marketing server 1440 to the digital marketing device, in this case, digital marketing device 1420 that initiated the request. In an embodiment of the invention, the first transfer file may be transferred to the file service module 1460 of the digital marketing device 1420.

As the first transfer file is being transferred from the digital marketing server 1440 to the client device 1420, a second or next transfer file is transferred 1040 from the digital marketing advertisement database 1416 to the digital marketing server 1440. In an embodiment of the invention, the path may be from the advertisement database 1416 to the database access module 1421 to the file service module 1460. In this embodiment, the file service module 1460 of the digital marketing server may transfer 1045 the second or next transfer file to the file service module 1423 of the first client device 1420. This continues until the updated advertisement content (the advertising files and the advertising schedule) has been completely transferred from the advertisement database 1416 to the digital marketing server 1440 to the client device 1420. In an embodiment of the invention, after the updated advertisement content has been transferred, the first connection object is deleted 1050 in the digital marketing server 1440.

At the same time or as the first digital marketing device 1420 is requesting updated advertising content and/or schedules, to be downloaded from the digital marketing server 1440, a second digital marketing device 1470 may also initiates 1055 a request to the digital marketing server 1440 to download its corresponding updated advertising content and/or schedule. As discussed above, the file service module 1473 of the digital marketing device 1470 communicates with the file service module 1460 of the digital marketing server 1440. After receiving the second digital marketing device's 1470 request, the digital marketing server 1440 verifies 1060 the authenticity of the second digital marketing device by contacting the control database 1413 of the digital marketing system.

After authentication of the second digital marketing device 1470, a second connection object or connection thread is created 1065 for the update request from the second digital marketing device 1470 and memory is allocated in the digital marketing server 1440 for the transfer of data to the second digital marketing device 1470. In embodiments of the invention, the digital marketing server 1440 continues to create connection objects or connection threads until a connection thread threshold is reached or alternatively, if memory is no longer sufficient to be allocated for another digital marketing device. Under certain operating conditions, the threshold is selectable and represents the maximum number of digital marketing devices that may be connected to the digital marketing server 1440, e.g., the file service module 1460 at one time.

After the second connection thread is created and memory is allocated in the digital marketing server, the digital marketing advertising database 1416 extracts 1070 a portion of the updated advertising content and/or schedule corresponding to the second digital marketing device 1470 and places the portion of the updated advertising content and/or schedule in a temporary file for transfer to the digital marketing server 1430. This may be referred to as a transfer file for the second digital marketing device 1470. In an embodiment of the invention, this extraction and creation of the transfer file may be occurring during the same time period as the creation of the transfer file for the first digital marketing device 1420. In other embodiments of the invention, the extraction and creation of the transfer file for the second digital marketing device may have to occur after the extraction and creation of the transfer file for the first digital marketing device 1420 is completed (e.g., if they are in the same region). If the first digital marketing device 1420 and the second digital marketing device 1470 are in the same region they may receive the same updated advertising content and advertising schedule.

This first transfer file of the updated advertising content for the second digital marketing device 1470 is transferred 1175 to the digital marketing server 1440 and then transferred 1180 to the second digital marketing device 1470. Illustratively, the first transfer file is transferred from the advertising database 1416 to the file service module 1416 of the digital marketing server 1440 and then on to the file service module 1473 of the second digital marketing device 1470. As noted above, downloading of the updated content for the second digital marketing device 1470 continues to occur until all of the updated advertising content and/or schedule has been transferred. After the all of the updated advertising content and/or schedule is downloaded, the second connection object is deleted 1185. The downloading of the updated advertising content and/or advertising schedule for the second digital marketing device 1470 may occur at the same time that one of the transfer size files are being transferred from the advertising database 1416 to the digital marketing server 1440 as part as part of the first connection object. Multiple connection objects or connection threads may be transferring updated advertising content from the advertising database 1416 to the digital marketing server 1440 at the same time or simultaneously. Under certain operating conditions, when transferring the first transfer file or the next transfer file from the digital marketing server 1440 to any one of the digital marketing devices, e.g., 1420 and 1470, the digital marketing server 1440 transmits one transfer file at a time utilizing a transfer layer protocol, e.g., TCP. Only one port is utilized on the digital marketing server 1440 to transmit the information to digital marketing devices, e.g., port 80, and thus a queue in the digital marketing server may hold multiple transfer files until the port is available for transmission (or has completed transmission of the previous transfer file).

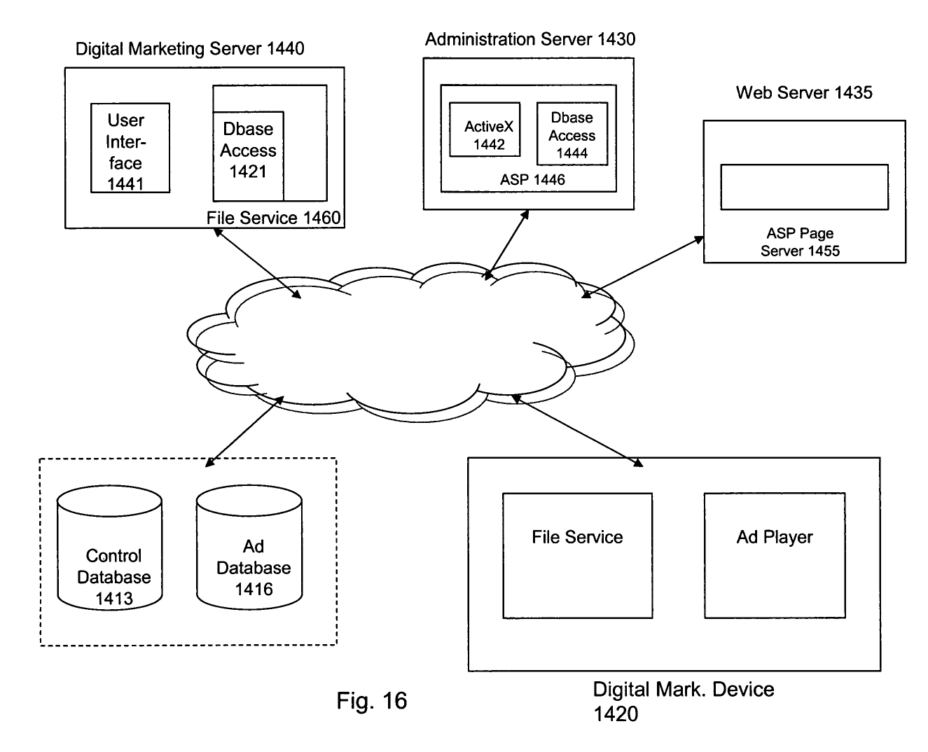

FIG. 16 illustrates information provided by a user interface module in a digital marketing system according to an embodiment of the present invention. The user interface module 1441 may provide an administrator with status on a number of resources of the digital marketing system 100. The user interface module 1441 may provide a visual indication or reference for all regions or all digital marketing devices within a digital marketing system 100. Further, the user interface module 1441 may provide a connectivity status for each of the digital marketing devices. In addition, the user interface module 1441 may provide detailed information about each of the clients connected or established within the system. The user interface module, which may be located within the digital marketing server 1440, interacts and communicates with the control database 1413 to retrieve this information. The control database 1413 retrieves the requested information. The control database transmits the region information from the control database 1413 to the user interface module 1441 in the digital marketing server 1440.

For example, an administrator may desire to provide a visual reference on a display of all of the regions within the digital marketing system. The user interface module 1441 is located within the digital marketing server 1440. The user interface module 1441 interacts with the database access module 1421 in the digital marketing server. Similarly, the administrator may request client (or digital marketing device) detailed information such as address, state, zip, IP address, market and location numbers, download history, and a currently download status.

The user interface module 1441 may allow an administrator to request information about specific terminals. For example, an administrator may request via the user interface module 1441 general information about each of the terminals, synchronization status of each of the terminals, or a history log for each of the terminals. Under certain operating conditions, an administrator, utilizing the user interface module 1441, may request a list of all digital marketing devices installed in the digital marketing system. Under certain operating conditions, an icon representing each of the digital marketing devices may be presented on a display of the administrator's terminal. If one of the icons is selected, more detailed information may be presented to the administrator, either graphically or textually. For example, address information, region location, IP address info, or unit number may be provided to the administrator. Under other operating conditions, a list of all of the digital marketing devices may be displayed in a tabular fashion. For example, a table may be presented having the following columns: device name, site number, region number, terminal or location ID, and IP address. The table can be sorted utilizing any of the columns, i.e., region, location, or site number.

Illustratively, an administrator may provide a connectivity status for each of the digital marketing devices. Under certain operating conditions, the connectivity status may be illustrated in the form of a report or list on the screen. Under certain operating conditions, the connectivity status may be illustrated in the form of an icon representing each of the digital marketing devices and a x or cross striking out the icon of the digital marketing device if the connectivity status is not active. Under certain operating conditions in the digital marketing system 100, the display of a terminal which interacts with a user interface module 1441 may display the results of connectivity status one at a time. In this manner, it appears that each of the digital marketing devices is being polled for a connectivity status. As mentioned above, the user interface module 1441 communicates with the database access module 1421 which in turn communicates with the control database 1416. The information regarding connectivity status that is extracted from the control database 1416 may be transmitted to the user interface module 1441. Under certain operating conditions, all of the information may be transmitted to the user interface module 1441 in one communication burst. Under other operating conditions, the information extracted from the control database 1413 may be transmitted for each digital marketing device one at a time. In an embodiment of the invention, the control database 1413 communicates with each of the digital marketing devices to determine their connectivity status. Illustratively, the control database 1413 may ping each of the digital marketing devices to determine their connectivity status. The control database 1413 may utilize an ICMP packet. In an embodiment of the invention, the user interface module 1441 may ping each of the digital marketing devices to determine their connectivity status. In this embodiment, the information about the connectivity status may then be transferred to the control database 1413 for storage.

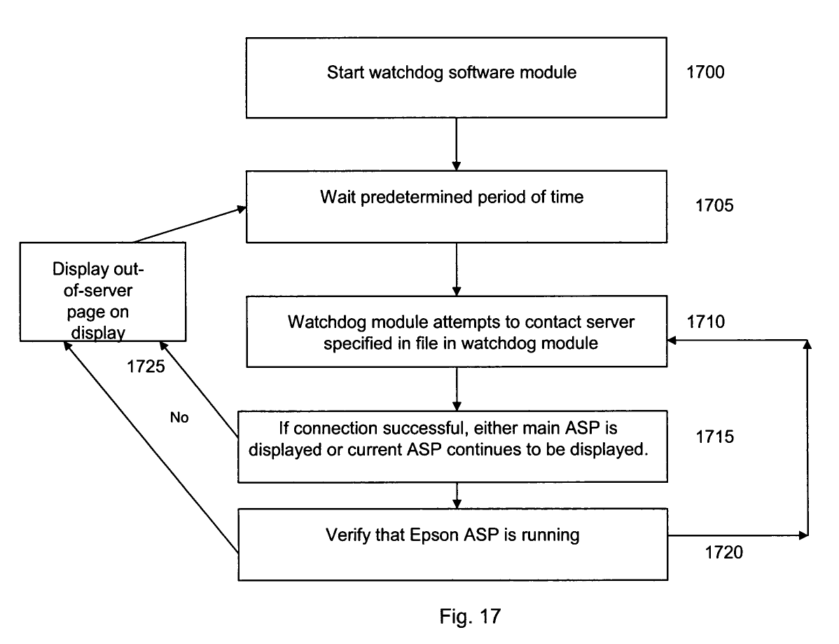

FIG. 17 illustrates a flowchart of a watchdog module according to an embodiment of the present invention. Each digital marketing device may include a watchdog to ensure that the digital marketing device is operating correctly. If the digital marketing device is not operating correctly, an out-of-service message or banner may be displayed on the digital marketing device. Under certain operating conditions, the watchdog module starts 1700 or instantiates a web browser, e.g., Microsoft Internet Explorer™. Under other operating conditions, the watchdog module is started or instantiated. The watchdog module waits 1705 a predetermined time period as specified by a file in the watchdog module. The administrator may establish this predetermined time period. The watchdog module may also have an established polling period. At one time during the established polling period, the watchdog module of the digital marketing device attempts 1710 to connect to a server that is specified by the file in the watchdog module. In an embodiment of the present invention, the server may be the digital marketing server 1440. In an embodiment of the invention, the attempting to connect with the server involves a pinging of the server. Under other operating conditions, the watchdog module of the digital marketing device may utilize a http request to attempt to contact the server. The digital marketing server 1440 or other server may be established or stored in an .ini file of the watchdog module. If the connection attempt is successful 1715 (and the previous ping was unsuccessful), the default home page of the digital marketing system 100 is displayed on the digital marketing device (if the watchdog module is being run when the digital marketing device is not being utilized). Under other operating conditions, the current active server page continues to be displayed as long as the watchdog module does not determine that the digital marketing device cannot communicate with the designated server. If the connection attempt is unsuccessful 1720, the display of the digital marketing device is set to an out of service web page or displays an out-of-service message. This may be a standard HTML web page, an active server page, or may be an out-of-service web page that is set in the .ini file of the watchdog module. In an embodiment of the invention, the watchdog module also checks 1725 to see what web page or active server page that is being displayed at the end of the established polling period. If the header of the web page being displayed does not include Epson, (meaning the digital marketing device is displaying a non-Epson or non-digital marketing system active server page), then the browser may be set to an out-of-service web page. The watchdog module continues to operate in the next established polling period.

The digital marketing system 100 monitors the playing of advertisements in all of the digital marketing devices 1820 1821 1822 in the digital marketing system. By monitoring the advertisements statistics, an administrator of the digital marketing system may keep track of how many times advertisements are run, how often the advertisements are run, how often the machine was being accessed, etc. This may be referred to as advertisement statistics information.

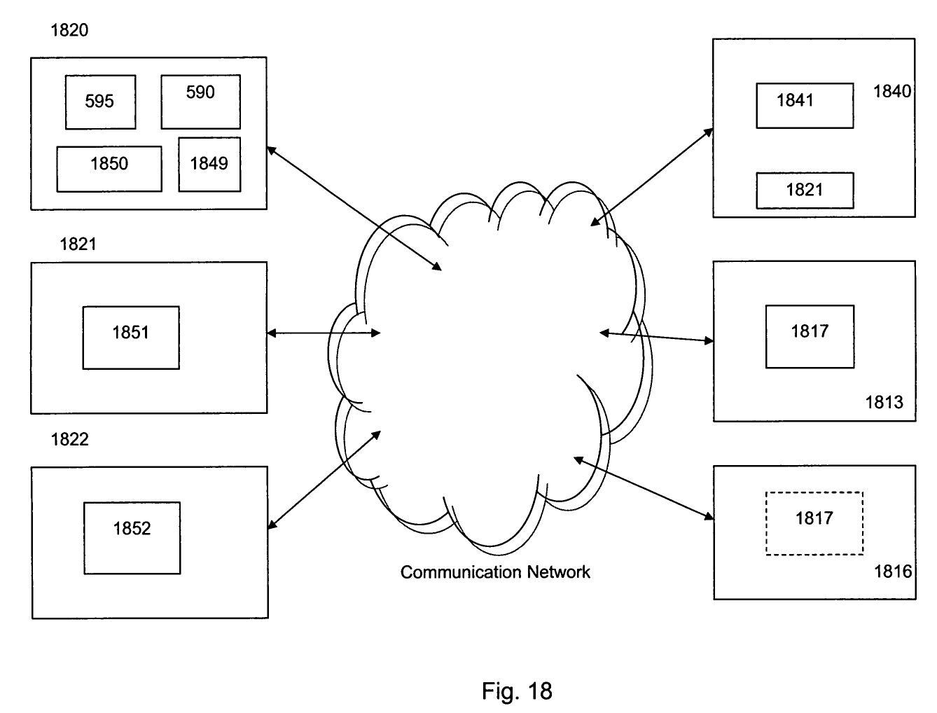

FIG. 18 illustrates monitoring of advertising and status information for digital marketing devices in a digital marketing system 100. Each digital marketing device 1820 1821 1822 in the digital marketing system includes a monitoring module 1850 1851 1852. A monitoring module 1850 keeps track on advertisements that are run on the respective digital marketing device. The monitoring module 1850 may be coupled to the player 595 and/or the ad control module 585. The player 595 or the ad control module 585 may transmit advertisement statistics information to the monitoring module 1850 and the monitoring module 1850 may store the advertisement statistics information in a non-volatile storage on the digital marketing device.

The monitoring module 1850 may also keep track of machine availability, e.g., whether the digital marketing device is operational or non-operational. Illustratively, the watchdog module 1851 may be notify the monitoring module that the digital marketing device 1820 1821 1822 is not operational or out-of-service. The monitoring module 1850 receives this information and may store this information in the non-volatile memory.

The watchdog module 1851 may also notify the monitoring module 1850 when the digital marketing device 1820 becomes operational again. In this manner, the monitoring module 1850 may keep track of how often the machine is non-operational. The monitoring module 1850 may also keep track of how often a digital marketing device 1820 is utilized in a digital marketing sense, i.e., where active server pages of the digital marketing system are being displayed rather an attract loop. In other words, the monitoring module 1850 may keep track of how long the attract loop is running on the digital marketing device and subtract that from how long the digital marketing device 1820 is turned on. This activation time or advertising time may be stored in non-volatile memory in the monitoring module 1850 or in the digital marketing device. The operational and advertising time information may be referred to as performance statistics.

The monitoring module 1850 may combine the performance statistics and the advertising information together into a single file called advertising and performance statistics. Under certain operating conditions, the advertising and performance statistics may be stored in a non-volatile memory in the digital marketing device. Each of the digital marketing devices 1820 1821 1822 may monitor for these statistics and may store this advertising and performance information. Under certain operating conditions, the advertising and performance information may be transferred from each of the digital marketing devices 1820 1821 and 1822 to the control database 1813. Under certain operating conditions, the advertising and performance information may be transferred from each of the digital marketing devices 1820 1821 and 1822 to the advertising database. This transfer may occur directly between the digital marketing devices 1820 1821 1822 and the control database 1813 or the advertising database 1816. In certain operating conditions, this transfer may occur either before, during, or after the digital marketing device 1820 1821 1822 are performing the periodic downloading of advertising content and an advertisement schedule. Under these operating conditions, the advertising and performance information may first be transferred from the digital marketing device 1820 1821 1822 to the digital marketing server 1840 and then to the advertising database 1816 or the control database 1816.

A statistics or performance module 1817 in the control database 1813 or the advertising database 1816 may collect the advertising and performance information supplied by each of the digital marketing devices 1820 1821 1822. The statistics or performance module 1817 may aggregate the daily advertising and performance information for each of the digital marketing devices 1820 1821 1822 to allow for reporting of information for the digital marketing system 100. The statistics or performance module 1817 may also create a record or an entry in a database of the advertising and performance information for every day for each digital marketing device. The statistics or performance module 1817 is the repository for this information and an administrator can query this module 1817 to gather selected or requested information. Illustratively, an administrator can utilize the user interface module of the digital marketing server 1840 and the database access module of the digital marketing server 1840 to query the statistics performance module and to gather aggregated advertising and performance information for a day or two days for the digital marketing devices 1820 1821 1822 in the digital marketing system 100.

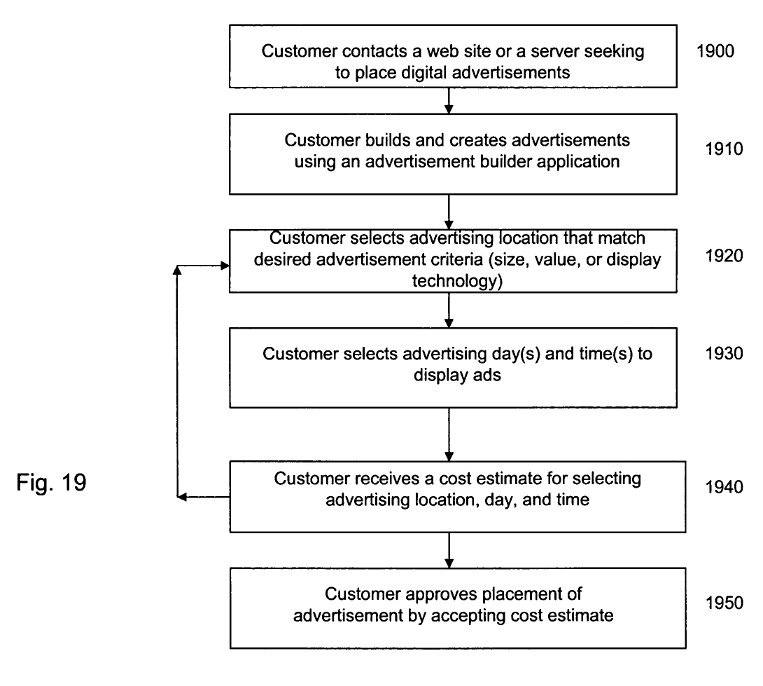

FIG. 19 illustrates a flowchart describing operation of a time and location selection advertising system according to an embodiment of the present invention. A time and location selection advertising system may be in place nationwide where the time and location selection advertising system allows a customer to decide when, where, and how often to place advertisements. In an embodiment of the invention, the time and location selection advertising system may be hosted on a computing device, e.g., a server, that is accessible via the Internet. A customer may access a global communications network, such as the Internet, and logon to the time and selection advertising server either via a dedicated software application or via a web browser.

The customer may enter or logon 1900 to the time and location advertising system, e.g., a time and location selection advertising web sever, in order to select a placement of a digital advertisement. A main screen may display various options for the time and location selection advertising. The digital advertisement may be a file or a number of files, where the file(s) are audio files, video files, flash media files, animation files, text files, image files, etc. In the embodiment of the invention illustrated in FIG. 19, the customer may not have yet have created an advertisement.

The customer may initiate an advertisement builder software application and may create 1910 a digital advertisement for the product or services they wish to advertise. In embodiments of the invention, the advertisement builder software may be initiated via clicking a selection button or clicking a prompt on a screen of a main web page of the time and location selection advertising system. In other embodiments of the invention, a customer may have to download the advertisement builder software application to the customer's computing device and may need to execute the advertisement builder software on the customer's computing device and then upload the built advertisement. In an embodiment of the invention, the advertisement builder software may be a plug-in to an Internet browser utilized by the customer. After creation of the digital advertisement, the customer recognizes and understands the digital advertisement's size limitations and display limitations. The ability to create an online advertisement is key to many customers. Illustratively, small business owners may not have the capital to spend large amount of money to have an advertising agency and graphical artist create an advertising campaign. In addition, in many cases, the process of creating an advertisement is very time consuming and the small business owner may not have the time or energy to complete this task.

Via the time and location selection advertising system, the customer may select 1920 advertising location(s) based on (a) the advertiser's perceived value of the location based on the advertising content; (b) the digital advertisement's size limitations; and (c) display technology limitations. In an embodiment of the invention, the customer may select advertising locations that match or can accommodate the size of the digital advertisements.

After the customer has selected the advertising location(s), the customer may select 1930 the time that the digital advertisements are to be displayed on the display devices, e.g., digital marketing devices. The customer may select which days the ads are to run and how often the advertisements are to run.

The time and location selection advertising system may generate 1940 a cost estimate for the digital advertisement's display at the selected location, on the selected days, and at the selected times. The cost of running or preparing the digital advertisement may depend on a number of factors. Some of the factors may include the 1) location of the advertisement; 2) the time of the day the ad is run (e.g., during the afternoon hours may be more expensive than late night hours); 3) the number of times the advertisement is run during the day; 4) the duration of the advertisement; and 5) the size of the advertisement.

In some cases, the cost estimate may be too large for the customer. Under these conditions, the customer would go back to the advertising location screen (e.g., step 1920) to adjust either the number of advertising locations and/or go back to the time selection screen (e.g., step 1930) to adjust the number of days or the frequency of the advertising display. Similarly, the customer may have additional advertising dollars to spend and may request additional locations and/or times in steps 1920 or 1930.

The customer may approve placement of the digital advertisement within the digital marketing system by approving 1950 the cost estimate generated by the time and location advertising selection screen. After the customer has approved the cost estimate, the digital advertisement can be entered into the advertisement database 1816 of the digital marketing system via techniques described above.

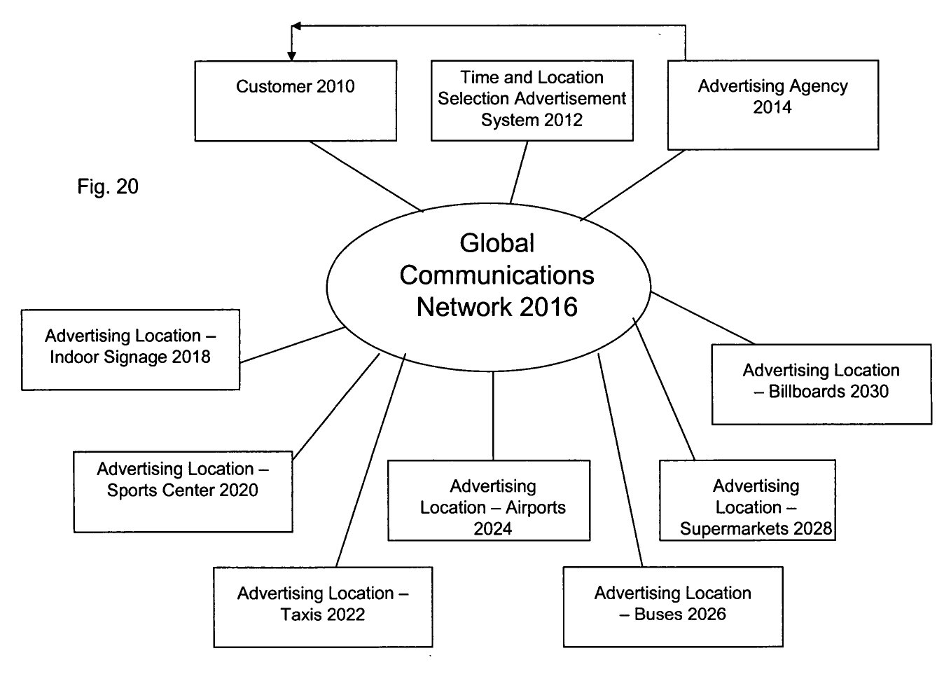

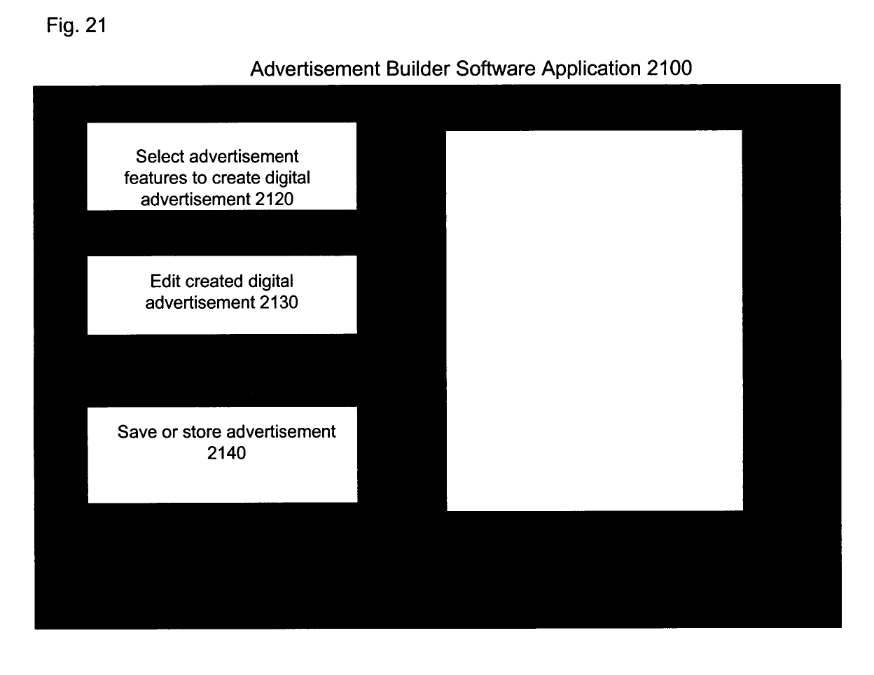

FIG. 20 illustrates a digital marketing system including a time and location selection advertisement system according to an embodiment of the present invention. The digital marketing system may include a customer system 2010 and a time and location selection advertisement system 2012 coupled to each other via a global communications network 2016. If a customer does not create its own digital advertisements, it may have an advertisement agency 2014 create the digital advertisement and then transmit the digital advertisement to either the customer system 2010 or the time and location selection advertisement system 2012. In an embodiment of the invention, the advertising agency may send the digital advertisement to the customer system 2010 or the time and location selection advertisement system 2012 via the global communications network.

The time and location selection advertisement system 2012 may allow placement of the digital advertisements at various advertising locations. As illustrated in FIG. 20, these locations may include an indoor signage location 2018, a sports center advertising location 2020, a taxi advertising location 2022, an airport advertising location 2024, a bus advertising location 2026, a supermarket advertising location 2028, and a billboard advertising location 2030. Some of the advertising locations may be mobile, e.g., a taxi location 2022 or a bus location 2026, and some of the advertising locations may be stationary, e.g., a supermarket location 2028.

FIG. 21 illustrates an advertisement builder software application input screen according to an embodiment of the present invention. The advertisement builder software input screen 2100 includes an advertisement display panel 2110, a select advertisement feature button or input panel 2120, a edit created digital advertisement button or input panel 2130, and a save/store advertisement placement button or input panel 2140.

When the select advertising feature button 2120 is selected, a number of images, clip art, background features, border options, etc., may appear on the screen. In other words, the selection is not only of a central image, but also may allow the selections of backgrounds, borders, text, sound clips, which together make the digital advertisement. As the customer selects various advertising features, the features are shown to the customer in the advertisement display panel.

When the edit created digital advertisement button 2130 is selected, a customer may select from available digital advertisements located the time and location advertisement selection system. The selected digital advertisement may be displayed in the advertisement display panel 2110 and the customer may add a new background, may change the background, may change contrast or brightness of the selected digital advertisement, etc.

Under certain operating conditions, when the save or store digital advertisement button 2140 is selected, the customer may save the digital advertisement that has just been created in either the customer system or in the time and location advertisement selection system. Under certain operating conditions, when the save or store digital advertisement button 2140 is selected, the customer may save the updated digital advertisement (after editing the digital advertisement using, for example, edit created digital advertisement button 2130) to either the customer system or the time and location advertisement selection system.

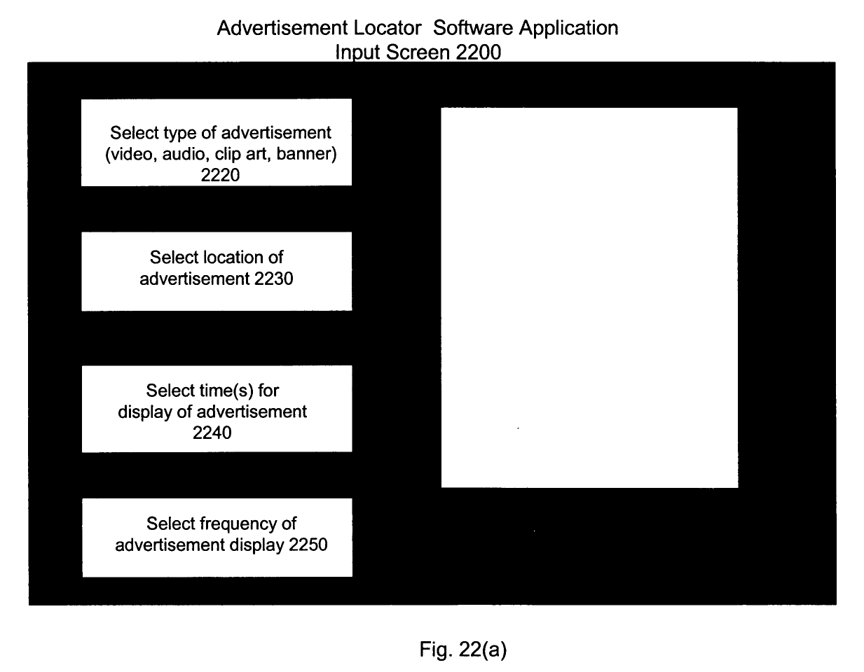

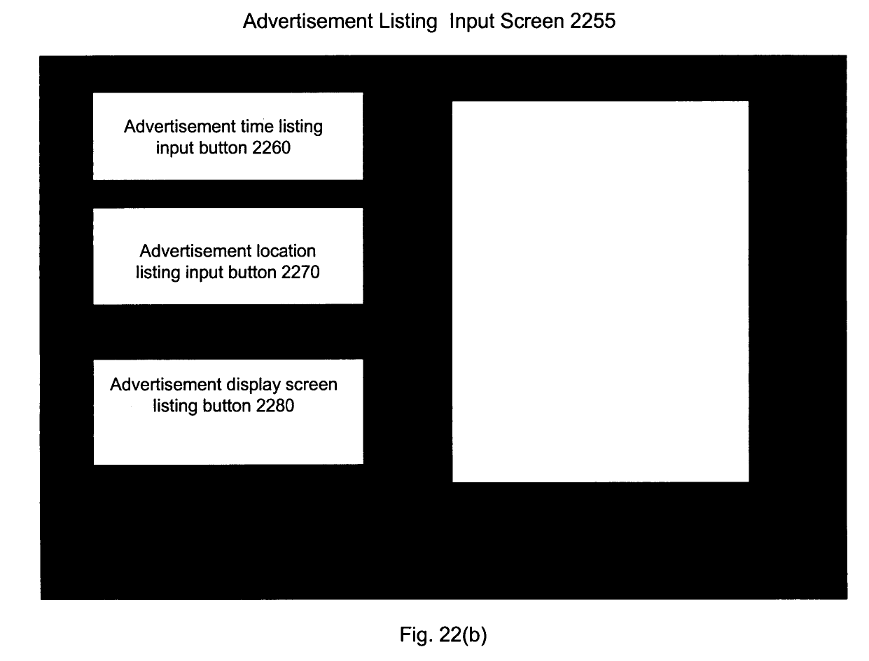

FIG. 22(a) illustrates an advertisement locator software application input screen according to an embodiment of the present invention. The advertisement location input screen 2200 is utilized, as part of the time and location selection advertisement system, to select the types of advertisements, the location of the advertisements, the time for the display of the advertisements, and the day that the advertisements are to be displayed. The advertisement location input screen 2200 may include a display panel 2210, a select type input button 2220, a select location input button or panel 2230, a select time input button or panel 2240, and a select day(s) input button or panel 2250.

If the select type input button 2220 is selected, the time and location selection advertisement system may present a number of advertisement types that are available on the system, if a digital advertisement does not already exist. If the customer has created a digital advertisement, the select type input button 2220 may allow the browsing of the customer system in order to select the newly created digital advertisement. Under other operating conditions, the select type input button 2220 may allow the browsing of the time and location selection advertisement system in order to select the newly created digital advertisement.

If the select location input button 2230 is depressed or chosen, the customer may select from a list of locations where digital advertisements may be displayed. Illustratively, that list may include a plurality of retail stores, a bus, outdoor signage, a taxi, a train, etc. Under certain operating conditions, the list may be displayed in the display panel 2210. Further, the customer can also visualize all locations, e.g. bus routes, train locations on train router, on a map displayed on display panel 2110. In addition, under certain operating conditions, current unavailable locations may be displayed with corresponding availability dates.

If the select time input button 2240 is depressed or chose, the customer may select from a number of times in which the digital advertisement(s) may be displayed. Illustratively, on the display panel 2210, a list of all times during the day, in 15 minute increments, may be displayed.

If the select day input button 2250 is depressed or chosen, the customer may select the days in the week in which to display the selected digital advertisement. A list of the available days may be presented to the customer in the display panel 2210. After all of the selections are made, the time and location selection advertising system may present a list of available advertising time slots matching all of the entered criteria in the display panel 2210. The display panel 2210 may also present or list the entered criteria.

FIG. 22(b) illustrates an advertisement listing input screen according to an embodiment of the present invention. The advertisement listing input screen 2255 may provide lists of information to the customer that describes the available advertising slots in a digital marketing system. Under certain operating conditions, this information is pulled from the advertisement database 916 and/or the control database 913 of the digital marketing system. The advertising listing input screen 2255 may include a display panel 2210, an advertisement time listing input button 2260, an advertisement location listing input button 2270, and a display screen listing input button 2280. If the advertising time listing input button 2260 is selected by the customer, the time and location selection advertising system may retrieve and present a list of all the advertising time slots that are available for the digital marketing system. The list may specify the location of the free or available time slot, the type of display that is to be utilized for the available time slot, how often the time slot is available (e.g. how many days), etc.

If the advertising location listing input button 2270 is selected, the time and location selection advertising system may retrieve and present a list of all the advertising locations that are available in the digital marketing system. The list may specify the time slots available at the advertising locations, the type of display that is to be used at the available location, and how often the time slot is available. If the display screen listing input button 2280 is selected, the time and location selection advertising system may retrieve and present a list of all the display types that are available for the digital marketing system. The list may also specify the location of the display types and the available time slots for the display types.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed:

1. A digital marketing system to display advertisements, comprising:
an advertisement database to store a plurality of digital advertisement files for a plurality of digital marketing devices;
a control database to store information about the plurality of digital marketing devices, the information including location information and log entry information; and
a first digital marketing device, coupled to the advertisement database and the control database via a communications network, to store a selected set of the plurality of digital advertisement files and to display the selected set of the plurality of digital advertisement files according to an advertising schedule, wherein
the selected set of the plurality of digital advertisement files are downloaded to the digital marketing device based on a region where the first digital marketing device is located and the advertising schedule is also downloaded to the first digital marketing device.

2. The digital marketing system of claim 1, further including a digital marketing server, coupled to the control database, the advertisement database, and the first digital marketing device to receive the selected set of the plurality of digital advertisement files and the advertising schedule, and to transfer the selected set of digital advertisement files and the advertising schedule to the first digital marketing device.

3. The digital marketing system of claim 1, wherein the first digital marketing device includes an advertisement control module to utilize the advertising schedule to transfer the selected set of digital advertisement files in an order specified by the advertising schedule, a player to receive the selected set of digital advertisement files, to decode the selected set of digital advertisement files, and to transfer the decoded selected set of digital advertisement files to a display of the first digital marketing device for display.

4. The digital marketing system of claim 3, wherein the first digital marketing device further includes a touchscreen display as the display and an active server page module to control the display of a plurality of active server pages for the digital marketing device, the active server page module initially displaying a main active server page for the first digital marketing device.

5. The digital marketing system of claim 4, wherein the active server page module responds to input entered via the touchscreen display to retrieve a new active server page corresponding to the input entered via the touchscreen display.

6. The digital marketing system of claim 5, wherein the new active server page is retrieved from a memory on the first digital marketing device.

7. The digital marketing system of claim 5, wherein the new active server page is retrieved from an active server page module which is external to the first digital marketing device.

8. The digital marketing system of claim 1, further including a second digital marketing device coupled to the advertisement database and the control database via a communications network, to store a second set of the plurality of digital advertisement files and to display the second set of the plurality of digital advertisement files according to a second advertising schedule, wherein
the second set of the plurality of digital advertisement files are downloaded to the digital marketing device based on a region where the second digital marketing device is located and the second advertising schedule is also downloaded to the second digital marketing device.

9. The digital advertising system of claim 1, further including a second digital marketing device coupled to the advertisement database and the control database via a communications network, to store the selected set of the plurality of digital advertisement files and to display the selected set of the plurality of digital advertisement files according to the advertising schedule, wherein the second digital marketing device is in the same region as the first digital marketing device.

10. A method of operating a digital marketing system, including:
receiving an advertisement update request from a first digital marketing device;
verifying the authenticity of the first digital marketing device;
creating a first connection object for the advertisement update request of the first digital marketing device to open a communication channel to an advertising database and allocating memory, in a digital marketing server, to provide for downloading of a plurality of advertising files corresponding to the advertisement update request; and
receiving a first transfer file of the plurality of advertising files into the memory of the digital marketing server.

11. The method of claim 10, further including transferring the first transfer file to the first digital marketing device and receiving a next transfer file of the plurality advertising files corresponding to the advertisement update request from the advertising database.

12. The method of claim 11, further including transferring the next transfer file to the first digital marketing device, receiving next transfer files from the advertising database until the plurality of transfer files corresponding to the advertisement update request are completely transferred, and transferring the next transfer files to the first digital marketing device.

13. The method of claim 12, further including deleting the first connection object to close the communication channel between the advertising database and a digital marketing server for the first digital marketing device.

14. The method of claim 10, further including receiving an advertisement update request from a second digital marketing device when the first connection object is open;
verifying the authenticity of the second digital marketing device;
creating a second connection object for the advertisement update request of the second digital marketing device to open a second communication channel to an advertising database and allocating memory, in a digital marketing server, to provide for downloading of a plurality of advertising files corresponding to the advertisement update request of the second digital marketing device; and
receiving a first transfer file of the plurality of advertising files, corresponding to the advertisement update request of the second digital marketing device, into the memory of the digital marketing server.

15. An article, comprising:
a machine-readable storage medium; and
machine-readable program code, stored on the machine-readable storage medium; having instructions, which when executed cause a digital marketing server to:
receive a request to update advertising content for a first digital marketing device;
verify that an identification corresponding to the first digital marketing device is an authorized device of a digital marketing system;
create a communication channel between the digital marketing server and the advertisement database, if the first digital marketing device is an authorized device, to allow for a transfer of the updated advertising content; and
receive a portion of the updated advertising content from the advertisement database and transfer the portion of the updated advertising content to the first digital marketing device.

16. The article of claim 15 including machine-readable program code having instructions which when executed cause the digital marketing server to:
receive a second portion of the updated advertising content corresponding to the request to update advertising content for the first digital marketing device, and
transfer the second portion of the updated advertising content to the first digital marketing device.

17. The article of claim 16, including machine-readable program code having instructions, which when executed, cause the digital marketing server to:
continue to receive portions of the updated advertising content from the advertisement database and to transfer the received portions to the first digital marketing device until a complete updated advertising content is transferred from the advertisement database for the first digital marketing device.

18. The article of claim 17, including machine-readable program code, having instructions, which when executed cause the digital marketing server to delete the first connection object to close the communication channel between the advertising database and a digital marketing server for the first digital marketing device.

19. The article of claim 15, including machine-readable program code, having instructions, which when executed cause the digital marketing server to:
receive a different request to update advertising content for a second digital marketing device;
verify that an identification corresponding to the second digital marketing device is an authorized identifier for the digital marketing system;
create a distinct communication channel between the digital marketing server and the advertisement database if the second digital marketing device is an authorized device to allow for a transfer of the updated advertising content; and
receive a portion of the updated advertising content for the second digital marketing device from the advertisement database and transfer the portion of the updated advertising content to the second digital marketing device, wherein the updated advertising content for the second digital marketing device is different from the updated advertising content for the first digital marketing device.

20. An article, comprising:
a machine-readable storage medium; and
machine-readable program code, stored on the machine-readable storage medium; having instructions, which when executed cause a computing device to:
create a digital advertisement having a range of physical sizes;
select an advertisement location having a display that accommodates the range of physical sizes for the digital advertisement;
select an advertising time including days and times in which the digital advertisement is to be displayed; and
create a cost estimate for a placement of the digital advertisement within a digital marketing network system based on the selected advertisement location and the selected advertisement time.
